(19) United States
(12) Patent Application Publication
(10) Pub. No.: US 2006/0256195 A1
(43) Pub. Date: Nov. 16, 2006

(54) Monitoring system, control apparatus and image capturing apparatus

(76) Inventor: Tetsuo Ogawa, Tokyo (JP)

Correspondence Address: J.C. PATENTS, SUITE 250, 4 VENTURE, IRVINE, CA, 92618, US

(21) Appl. No.: 11/408,424

(22) Filed: Apr. 21, 2006

Related U.S. Application Data
(63) Continuation-in-part of application No. PCT/JP04/15536, filed on Oct. 20, 2004.

(30) Foreign Application Priority Data
Oct. 21, 2003 (JP) JP 2003-360871

(51) Int. Cl. H04N 7/18; H04N 9/47

(52) U.S. Cl. 348/143

(57) ABSTRACT

There is provided a monitoring system having a plurality of sensors for detecting external environment at different locations, image capturing apparatuses connected with a communication network and a control apparatus for controlling the image capturing apparatuses, wherein the control apparatus has an environment inputting section for inputting an environment value representing the external environment from each of the plurality of sensors and a trap control section for transmitting an image capturing direction specifying trap message instructing to capture images in an image capturing direction corresponding to the sensor to the image capturing apparatus when the environment value meets with a preset condition corresponding to the sensor, and the image capturing apparatus has a camera section for capturing images, a driving section for changing the image capturing direction of the camera section and a driving control section for controlling the driving section to direct the camera section in the image capturing direction specified by the image capturing direction specifying trap message so that the camera section captures images in the image capturing direction.

### CROSS REFERENCE TO RELATED APPLICATION

This is a continuation application of PCT/JP2004/015536 filed on Oct. 20, 2004 which claims priority from a Japanese Patent Application No. 2003-360871 filed on Oct. 21, 2003, the contents of which are incorporated herein by reference.

### BACKGROUND OF THE INVENTION

1. Field of the Invention

The present invention relates to a monitoring system, a control apparatus and an image capturing apparatus. More specifically, the invention relates to a monitoring system, a control apparatus and an image capturing apparatus for monitoring a plurality of areas-under-monitoring via a network.

2. Related Art

Conventionally, there has been used a technology of providing images of a remote place to a user by enabling the user to control a camera set in a nursery school for example through Web page. It is a general practice to provide a personal computer and the like connected to Internet to control the camera in such a system. Then, the personal computer receives contents of manipulation of the user Fitted through HTTP (Hyper Text Transfer Protocol) and makes control such as changes of image capturing direction of the camera in accordance to the contents of manipulation.

It is noted that the present applicant is unaware of existence of a document of the prior art at present time, so that description related to the prior art document will be omitted here.

It is possible to connect a numerous number of cameras to Internet and to obtain images captured by those cameras by applying the function of displaying images captured by the cameras at the remote place via Internet. However, when this function is applied to a monitoring system, a monitor is obliged to select a camera capturing an abnormal state among the enormous number of cameras and hence it is difficult to increase the number of cameras to be monitored. Still more, when a plurality of places is to be monitored from different image capturing directions by each camera, the number of cameras to be monitored must be reduced further because the monitor is required to manipulate the selected camera to search for a place where an abnormality has occurred.

### SUMMARY OF THE INVENTION

Accordingly, it is an object of the invention to provide a monitoring system, a control apparatus and an image capturing apparatus, which are capable of solving the above-mentioned problems. This object may be achieved through the combination of features described in independent claims of the invention. Dependent claims thereof specify preferable embodiments of the invention.

According to a first aspect of the invention, there is provided a monitoring system having a plurality of sensors, provided at different locations, for detecting external environment in each location, image capturing apparatuses connected with a communication network and a control apparatus, connected with the plurality of sensors and the communication network, for controlling the image capturing apparatuses, wherein the control apparatus has an environment inputting section for inputting an environment value representing the external environment of the location where the sensor is set from each one of the plurality of sensors and a trap control section for transmitting an image capturing direction specifying trap message that is a SNMP-based trap message (Simple Network Management Protocol) instructing to capture images in an image capturing direction set in advance corresponding to the sensor to the image capturing apparatus via the communication network when the environment value inputted from the sensor meets with a preset condition set in advance corresponding to the sensor, and the image capturing apparatus has a camera section for capturing images, a driving section for changing the image capturing direction of the camera section and a driving control section for controlling the driving section to direct the camera section in the image capturing direction specified by the image capturing direction specifying trap message so that the camera section captures images in the image capturing direction

The monitoring system may have a plurality of sets of the plurality of sensors, the image capturing apparatus, the control apparatus and a monitoring apparatus for displaying images captured by one of the image capturing apparatuses, the trap control section of each of the plurality of control apparatuses may transmit an image capturing apparatus specifying trap message that is a SNMP-based trap message containing image capturing apparatus identifying information for identifying the image capturing apparatus controlled by the control apparatus to the monitoring apparatus when the environment value inputted from the sensor meets with the preset condition, and the monitoring apparatus may select and display images captured by the image capturing apparatus specified by the image capturing apparatus identifying information contained in the image capturing apparatus specifying trap message among a plurality of images captured respectively by the plurality of image capturing apparatuses.

The control apparatus may further include a magnification selecting section for selecting magnification of images captured by the image capturing apparatus based on the environment value, the trap control section may transmit a magnification specifying trap message that is a SNMP-based trap message containing the magnification to the image capturing apparatus via the communication network and the image capturing apparatus may further include a magnification control section for setting the magnification of the images captured by the image capturing apparatus to the magnification contained in the magnification specifying trap message received via the communication network.

At least one of the sensors may be a temperature sensor for detecting temperature at the location where the sensor is set, and when temperature detected by the temperature sensor is high, the magnification selecting section may select lower magnification as compared to a case when the temperature is low.

The trap control section may transmit the image capturing direction specifying trap message containing sensor identifying information for identifying the sensor to the image capturing apparatus when the environment value inputted from the sensor meets with a preset condition set in advance corresponding to the sensor, tee image capturing apparatus play include an image capturing direction storage section for storing sensor identifying information for identifying each of the plurality of sensors and image capturing direction information representing an image capturing direction in which the camera section should capture images when the environment value inputted from the sensor meets with the preset condition and an image capturing direction information selecting section for selecting the image capturing direction information corresponding to the sensor identifying information contained in the image capturing direction specifying trap message received via the communication network from the image capturing direction storage section, and the driving control section may control the driving section based on the selected image capturing direction information to direct the camera section in an image capturing direction defined by the image capturing direction information and to cause the camera section to capture images in the image capturing direction

The control apparatus may fierier include a sensor combination identifying information generating section for generating sensor combination identifying information for identifying a combination of the sensors whose environment values meet with the preset condition when the environment values of the two or more sensors meet with the preset condition, the trap control section may transmit the image capturing direction specifying trap message containing the sensor combination identifying information to the image capturing apparatus via the communication network, the image capturing direction storage section may further store the sensor combination identifying information and the image capturing direction information representing an image capturing direction in which the camera section should capture images when the environment values of the two or more sensors contained in the combination of the sensors identified by the sensor combination identifying information meet with the preset condition, and the image capturing direction information selecting section may select the image capturing direction information corresponding to the sensor combination identifying information contained in the image capturing direction specifying trap message received via the communication network out of the image capturing direction storage section.

Each one of the plurality of sensors may be a temperature sensor for detecting temperature at the location where the sensor is set, the control apparatus may further include a target image capturing direction deciding section for deciding a target image capturing direction in which the image capturing apparatus should capture images based on temperature detected by each one of two or more temperature sensors that have detected temperature exceeding preset temperature when the temperature detected by each one of the two or more temperature sensors exceeds the preset temperature set as the preset condition of the temperature sensors, a temperature sensor selecting section for selecting one of the temperature sensors that has detected the temperature exceeding the preset temperature set as the preset condition, and a difference information calculating section for calculating difference information representing a difference between the target image capturing direction and the image capturing direction defined by the image capturing direction information stored in the image capturing direction storage section corresponding to one of the temperature sensors, the trap control section may transmit the image capturing direction specifying trap message containing the sensor identifying information of one of the temperature sensors and an image capturing direction difference specifying trap message that is a SNMP-based trap message containing the difference information respectively to the image capturing apparatus via the communication network, and the driving control section may control the driving section based on the image capturing direction information corresponding to the sensor identifying information of one of the temperature sensors contained in the image capturing direction specifying trap message and the difference information contained in the image capturing direction difference specifying trap message to direct the image capturing apparatus in the target image capturing direction and to cause the image capturing apparatus to capture images in the image capturing direction.

The monitoring system may further include a monitoring apparatus for displaying images captured by the image capturing apparatus and when a manager of the monitoring apparatus inputs an instruction of changing the image capturing direction in which the image capturing apparatus captures the image, for transmitting an image capturing direction changing request message containing the instruction to the control apparatus, wherein the trap control section may transmit an image capturing direction changing trap message that is a SNMP-based trap message instructing to change the image capturing direction in the direction specified by the image capturing direction changing request message when it receives the image capturing direction changing request message firm the monitoring apparatus and the driving control section of the image capturing apparatus may direct the camera section in the image capturing direction specified by the image capturing direction changing trap message by controlling the driving section when it receives the image capturing direction changing trap message.

The monitoring system may further include first and second monitoring apparatuses, wherein the trap control section may transmit an image capturing apparatus specifying trap message that is a SNMP-based trap message further to the first monitoring apparatus when the environment value inputted from the sensor meets with the preset condition the first monitoring apparatus may display the image captured by the image capturing apparatus when it receives the image capturing apparatus specifying trap message, the trap control section may transmit the image capturing direction changing trap message instructing to change the image capturing direction in the direction specified by the image capturing direction changing request message to the image capturing apparatus when it receives the image capturing direction changing request message from the first monitoring apparatus or when it receives the image capturing direction changing request message from the second monitoring apparatus in a state in which no image capturing apparatus specifying trap message is transmitted to the first monitoring apparatus for a period determined in advance, and the driving control section of the image capturing apparatus may control the driving section to direct the camera section in the image capturing direction specified by the image capturing direction changing trap message when it receives the image capturing direction changing trap message.

The trap control section may transmit a manipulation prohibiting trap message that is a SNMP-based trap message representing that no instruction of changing the image capturing direction in which the image capturing apparatus captures images will be accepted from the second monitoring apparatus to the second monitoring apparatus when the environment value inputted from the sensor meets with the preset condition and the second monitoring apparatus may prohibit the manager of the second monitoring apparatus from changing the image capturing direction for a period set in advance when it receives the manipulation prohibiting trap message.

The trap control section may also transmit a manipulation prohibiting trap message that is a SNMP-based trap message representing that no instruction of changing the image capturing direction in which the image capturing apparatus captures images will be accepted from the second monitoring apparatus to the second monitoring apparatus when the environment value inputted from the sensor meets with the preset condition and the second monitoring apparatus may display images captured before receiving the manipulation prohibiting trap message for a period set in advance when it receives the manipulation prohibiting trap message.

The monitoring system may further include a plurality of image capturing apparatuses, a monitoring apparatus for displaying images captured by one of the image capturing apparatuses and an image selecting unit for selecting an image to be displayed on the monitoring apparatus among images captured respectively by the plurality of image capturing apparatuses to transmit the image to the monitoring apparatus, the control apparatus may further include a sensor correlated information storage section for storing sensor identifying information for identifying each of the plurality of sensors by correlating with image capturing apparatus identifying information for identifying the image capturing apparatus whose captured image should be transmitted to the monitoring apparatus among the plurality of image capturing apparatuses when the environment value inputted from the sensor meets with the preset condition and an image capturing apparatus identifying information selecting section for selecting the image capturing apparatus identifying information corresponding to the sensor out of the sensor correlated information storage section when the environment value inputted from the sensor meets with the preset condition, the trap control section may transmit an image capturing apparatus selecting trap message that is a SNMP-based trap message containing the image capturing apparatus identifying information selected by the image capturing apparatus identifying information selecting section to the image selecting unit via the communication network, and the image selecting unit may select the image captured by the image capturing apparatus specified by the image capturing apparatus identifying information contained in the image capturing apparatus selecting trap message as the image to be displayed on the monitoring apparatus and may transmit the image to the monitoring apparatus.

The monitoring system may further include a plurality of sets of the plurality of sensors, the image capturing apparatus and the control apparatus and a plurality of monitoring apparatuses for displaying images captured by one of the image capturing apparatuses, wherein each of the control apparatuses further may include a preset condition storage section for storing the preset condition corresponding to each of the plurality of sensors in response to each one of the plurality of monitoring apparatuses, the trap control section of each of the control apparatuses may transmit the image capturing direction specifying trap message instructing to capture images in an image capturing direction set in advance corresponding to the sensor to the image capturing apparatus controlled by the control apparatus via the communication network and may transmit an image capturing apparatus specifying trap message that is a SNMP-based trap message containing image capturing apparatus identifying information for identifying the image capturing apparatus controlled by the control apparatus to the monitoring apparatus when the environment value inputted from the sensor connected to the control apparatus meets with the preset condition corresponding to the monitoring apparatus and the sensor for each of the plurality of monitoring apparatuses, and each of the plurality of monitoring apparatuses may select and display the image captured by the image capturing apparatus specified by the image capturing apparatus identifying information contained in the image capturing apparatus specifying trap message among the plurality of images captured respectively by the plurality of image capturing apparatuses.

According to a second aspect of the invention, there is provided a monitoring system having a plurality of sets of a plurality of sensors set at different locations to detect external environment at each location, an image capturing apparatus connected to a communication network and a control apparatus, connected with the plurality of sensors and the communication network for controlling the image capturing apparatus, and a monitoring apparatus for displaying an image captured by one of the image capturing apparatuses, wherein each one of the plurality of control apparatuses has an environment inputting section for inputting an environment value representing the external environment at the location where the sensor is set from each one of the plurality of sensors connected with the control apparatus and a message control section for transmitting an image capturing direction specifying message instruct to capture an image in an image capturing direction set in advance corresponding to the sensor to the image capturing apparatus controlled by the control apparatus via the communication network with which the control apparatus is connected and for transmitting an image capturing apparatus specifying message containing image capturing apparatus identifying information for identifying the control apparatus to the monitoring apparatus when the environment value inputted from the sensor meets with a preset condition set in advance corresponding to the sensor, each one of the plurality of image capturing apparatuses has a camera section for capturing images, a driving section for changing an image capturing direction of the camera section and a driving control section for controlling the driving section to direct the camera section in the image capturing direction specified by the image capturing direction specifying message and to cause the camera section to capture the image in the image capturing direction, and the monitoring apparatus selects and displays the image captured by the image capturing apparatus specified by the image capturing apparatus identifying information contained in the image capturing apparatus specified message among a plurality of images captured respectively by the plurality of image capturing apparatuses.

According to a third aspect of the invention, there is provided a control apparatus, connected with a plurality of sensors and a communication network, for controlling an image capturing apparatus in a monitoring system having the plurality of sensors set at different locations to detect external environment at each location and the image capturing apparatus connected with the communication network, having an environment inputting section for inputting an environment value representing the external environment at the location where the sensor is set from the plurality of sensors and a trap control section for transmitting an image capturing direction specifying trap message that is a SNMP (Simple Network Management Protocol)-based trap message instructing to capture an image in an image capturing direction set in advance corresponding to the sensor to the image capturing apparatus via the communication network to cause the image capturing apparatus to capture the image in the image capturing direction specified by the image capturing direction specifying trap message when the environment value inputted from the sensor meets with a preset condition set in advance corresponding to the sensor.

According to a fourth aspect of the invention, there is provided a control apparatus in a monitoring system having a plurality of sets of a plurality of sensors set at different locations to detect external environment at each location, an image capturing apparatus connected with a communication network and a control apparatus, connected with the plurality of sensors and the communication network for controlling the image capturing apparatus as well as a monitoring apparatus for displaying an image captured by one of the image capturing apparatuses, having an environment inputting section for inputting an environment value representing the external environment at the location where the sensor is set from the plurality of sensors connected with the control apparatus and a message control section for transmitting an image capturing direction specifying message instructing to capture an image in an image capturing direction set in advance corresponding to the sensor to the image capturing apparatus controlled by the control apparatus via the communication network to cause the image capturing apparatus to capture the image in the image capturing direction specified by the image capturing direction specifying trap message and for transmitting an image capturing apparatus specifying message containing image capturing apparatus identifying information for identifying the image capturing apparatus to the monitoring apparatus to cause the monitoring apparatus to select and display the image captured by the image capturing apparatus when the environment value inputted from the sensor meets with a preset condition set in advance corresponding to the sensor.

According to a fifth aspect of the invention, there is provided an image capturing apparatus in a monitoring system having a plurality of sensors set at different locations to detect external environment at each location, an image capturing apparatus connected with a communication network and a control apparatus, connected with the plurality of sensors and the communication network, for controlling the image capturing apparatus, wherein tae control apparatus has an environment inputting section for inputting an environment value representing the eternal environment at the location where the sensor is set from the plurality of sensors and a trap control section for transmitting an image capturing direction specifying trap message that is a SNMP (Simple Network Management Protocol)-based trap message instructing to capture an image in an image capturing direction set in advance corresponding to the sensor to the image capturing apparatus via the communication network when the environment value inputted from the sensor meets with a preset condition set in advance corresponding to the sensor, the image capturing apparatus has a camera section for capturing images, a driving section for changing au image capturing direction of the camera section and a driving control section for controlling the driving section to direct the camels section in the image capturing direction specified by the image capturing direction specifying trap message and to cause the camera section to capture the image in the image capturing direction.

It is noted that the summary of the invention described above does not necessarily describe all necessary features of the invention. The invention way also be a sub-combination of the features described above.

The invention can thus provide the monitoring system that allows efficient monitoring to be made by using a large number of cameras connected to Internet.

### BRIEF DESCRIPTION OF THE DRAWINGS

FIG. 1 is a diagram showing a configuration of a monitoring system 10 according an embodiment of the invention.

FIG. 2 is a diagram showing a configuration of a control apparatus 130 according to the embodiment of the invention.

FIG. 3 is a diagram showing a configuration of an environment inputting section 200 and a MIB storage section 210 according to the embodiment of the invention.

FIG. 4 shows one exemplary configuration of MIB stored in the MIB storage section 210 according the embodiment of the invention.

FIG. 5 is a diagram showing one exemplary hardware configuration of the control apparatus 130 according the embodiment of the invention.

FIGS. 6A and 613 show one exemplary script executed in a control processor 530 according to the embodiment of the invention, wherein FIG. 6A shows a first script and FIG. 6B shows a second script, respectively.

FIG. 7 shows an operation flow of the control apparatus 130 according to the embodiment of the invention.

FIG. 8 shows a configuration of au image capturing apparatus 120 according the embodiment of the invention

FIG. 9 shows an operation flow of the image capturing apparatus 120 according the embodiment of the invention.

FIG. 10 shows another configuration of the area-under-monitoring 100 according to the embodiment of the invention.

FIG. 11 shows a configuration of a computer 900 according to the embodiment of the invention.

### DETAILED DESCRIPTION OF THE INVENTION

The invention will now be described based on preferred embodiments, which do not intend to limit the scope of the invention, but exemplify the invention. All of the features and the combinations thereof described in the embodiments are not necessarily essential to the invention

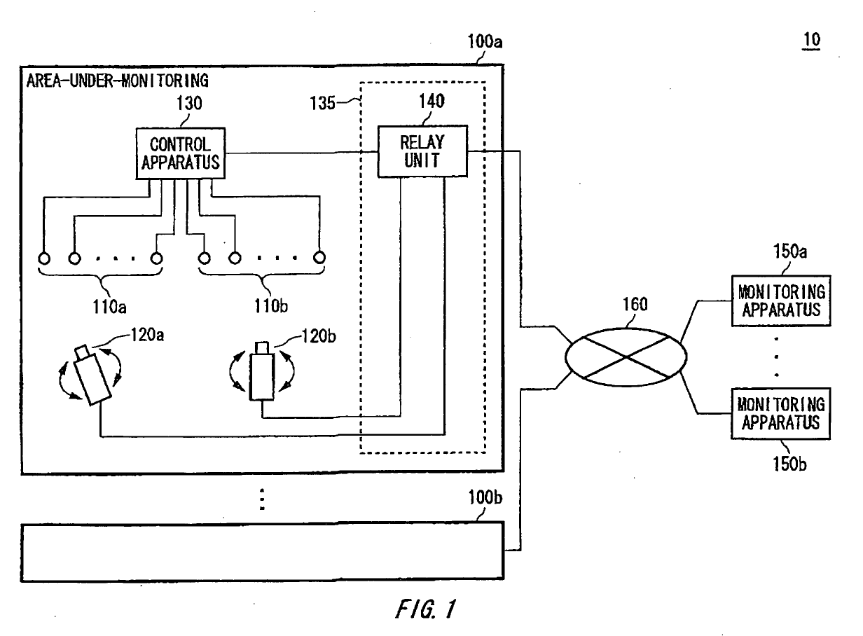

FIG. 1 is a diagram showing a configuration of a monitoring system 10 according an embodiment of the invention. The monitoring system 10 is a system having a plurality of areas-under-monitoring 100 (100a, 100b) to be monitored such as homes, offices, factories, transport facilities, amusement parks and the like, a network 160 such as WAN and LAN and one or a plurality of monitoring apparatuses 150 (150a, 150b) and monitoring the area-under-monitoring 100 by displaying images captured by image capturing apparatuses 120 set within each area-under-monitoring 100 on the monitoring apparatus 150.

Each one of the areas-under-monitoring 100a and 100b has a set of a plurality of sensors 110 (110a and 110b), one or a plurality of image capturing apparatuses 120 (120a, 120b), a control apparatus 130 and a communication network 135. Because the area-under-monitoring 100b has the same function and configuration with the area-under-monitoring 100a, the area-under-monitoring 100a will be mainly explained below except of some differences.

The plurality of sensors 110 is set at different locations to detect external environment at each location Each sensor 110 may be a temperature sensor, a humidity sensor, a smoke sensor, a water sensor, a gas leakage sensor, a vibration sensor, a door opening/closing sensor and the like and may detect, as the external environment, temperature, humidity, whether or not smoke exists, whether or not water is leaking, whether or not gas is leaking, whether or not vibration exists, whether or not a door is opened/closed and the like. Here, the sensor 110 may be either an analog sensor that outputs an environmental value representing the external environment at the location where the sensor 110 is set as an analog signal or be a digital sensor that outputs the value as a digital signal.

Each of the plurality of image capturing apparatuses 120 is connected to a communication network 135 to transmit captured images to the monitoring apparatus 150 via a relay unit 140 and the network 160. Here, the images captured by the plurality of image capturing apparatuses 120 may be video images or still images and may be image data containing voice. In the present embodiment, the image capturing apparatus 120a is set in correspondence to the plurality of sensors 110a and the image capturing apparatus 120b is set in correspondence to the plurality of sensors 10b.

The control apparatus 130 is connected with the plurality of sensors 110 and the communication network 135 and controls an image capturing direction, magnification and the like of the image capturing apparatuses 120a and 120b based on the environmental values representing the external environment received from the respective one of the plurality of sensors 110. Still more, when it is required to monitor from the monitoring apparatus 150 because the environment value received from the plurality of sensors 110 represents an abnormal value for example, the control apparatus 130 informs the monitoring apparatus 150 of the image capturing apparatus 120 to be monitored by the monitoring apparatus 150.

The communication network 135 is LAN provided within the area-under-monitoring 100a for example and includes the relay unit 140 for connecting the plurality of image capturing apparatuses 120, the control apparatus 130 and the network 160. The relay unit 140 functions as an image selector for selecting images to be displayed on the monitoring apparatuses 150a and 150b among the images captured by the plurality of image capturing apparatuses 120a and 120b based on the instruction of the control apparatus 130 and for transmitting the images to the monitoring apparatuses 150a and 150b.

Based on the information received from the control apparatus 130 and specifying the image capturing apparatus 120 to be monitored, the monitoring apparatus 150 selects and displays images captured by one image capturing apparatus 120 among one or the plurality of image capturing apparatuses 120 of each of the plurality of areas-under-monitoring 100. Still more, when a manager of the monitoring apparatus 150 inputs an instruction of changing the image capturing direction or magnification of the image capturing apparatus 120, the monitoring apparatus 150 sends an image capturing direction changing request message or a magnification changing request message containing the instruction to the control apparatus 130 to change the image capturing direction or the magnification of the image capturing apparatus 120.

Here, each of the monitoring apparatuses 150a and 150b may monitor different types of object in the plurality of areas-under-monitoring 100. That is, a disaster prevention center may provide the monitoring apparatus 150a to monitor fires in the areas-under-monitoring 100a and 100b and a guard company may provide the monitoring apparatus 150b to monitor trespass into the areas-under-monitoring 100a and 100b.

According to the monitoring system 10 described above, when the control apparatus 130 receives an environment value representing that an abnormality has occurred in the external environment from at least one of the plurality of sensors 110, the control apparatus 130 directs the image capturing apparatus 120 in the image capturing direction so that it can capture an image of such abnormality and informs the monitoring apparatus 150 that the image capturing apparatus 120 should be monitored. Then, the monitoring apparatus 150 can display the images capturing the abnormality or the like for the monitor without receiving any manipulation of the monitor by displaying the images of the image capturing apparatus 120 by receiving such information.

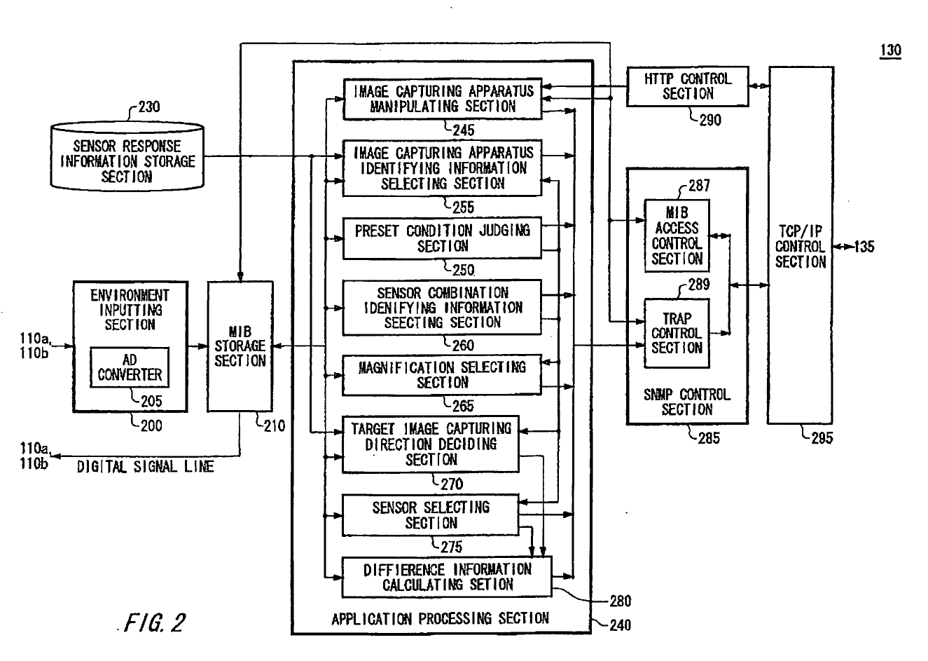

FIG. 2 is a diagram showing a configuration of the control apparatus 130 according to the embodiment of the invention. The control apparatus 130 has an environment inputting section 200, a MIB storage section 210, a sensor correlated information storage section 230, an application processing section 240, a SNMP control section 285, a H control section 290 and a TCP/IP control section 295.

The environment inputting section 200 receives the environment value representing the external environment at the location where the sensor 110 is set from each one of the plurality of sensors. The environment inputting section 200 includes an AD converter 205 for converting an analog environment value inputted from an analog sensor 110 into a digital environment value.

The MS storage section 210 stores the environment value inputted from each one of the plurality of sensors 110 by correlating with MID (Management Information Base) object in SNMP. Instead of that, the MIB storage section 210 may store those environment values by using a data structure defined in the future based on the MIB. The MIB storage section 210 may also store those environment values as a data structure accessed by a method other than SNP such as SOAP (Simple Object Access Protocol).

The sensor correlated information storage section 230 stores sensor identifying information for identifying each one of the plurality of sensors 110 by correlating with image capturing apparatus identifying information for identifying the image capturing apparatus 120 that should transmit captured images to the monitoring apparatus 150 among the plurality of image capturing apparatuses 120 when the environment value inputted from the sensor 110 meets with a preset condition.

When the environment value stored in the MIB storage section 210 meets with the preset condition, the application processing section 240 selects the image capturing apparatus 120 corresponding to the sensor 110 that has detected the environment value meeting with the preset condition and decides an image capturing direction and/or magnification of the image capturing apparatus 120. The application processing section 240 includes an image capturing apparatus manipulating section 245, a preset condition judging section 250, a sensor combination identifying information generating section 260, an image capturing apparatus identifying information selecting section 255, a magnification selecting section 265, a target image capturing direction deciding section 270, a temperature sensor selecting section 275 and a difference information calculating section 280.

Receiving an instruction of changing the image capturing direction and/or magnification of the image capturing apparatus 120 from the monitoring apparatus 150, the image capturing apparatus manipulating section 245 decides the image capturing direction and/or magnification of the image capturing apparatus 120 based on the instruction. The preset condition judging section 250 judges whether or not the environment value inputted from the sensor 110 meets with the preset condition set in advance corresponding to the sensor 110. The preset condition corresponding to the sensor 110 is a condition set in advance corresponding to the sensor 110 and used by the application processing section 240 to judge whether or not the external environment corresponding to the sensor 110 should be monitored. This preset condition may be set individually corresponding to each of the plurality of monitoring apparatus 150. Then, the preset condition judging section 250 generates sensor identifying information of the sensor 110 whose environment value meets with the preset condition.

When the environment values of two or more sensors 110 meet with the preset condition, the sensor combination identifying information generating section 260 generates sensor combination identifying information for identifying a combination of the sensors 110 whose environment values meet with the preset condition.

Receiving the sensor identifying information of the sensor 110 whose environment value meets with the preset condition from the preset condition judging section 250 or the sensor combination identifying information for identifying a combination of the sensors 110 whose environment values meet with the preset condition from the sensor combination identifying information generating section 260, the image capturing apparatus identifying information selecting section 255 selects image capturing apparatus identifying information corresponding to the sensors 110 from the sensor correlated information storage section 230. Thereby, the image capturing apparatus identifying information selecting section 255 can select the image capturing apparatus 120 capable of capturing images of the location where the sensor 110 or the combination of the sensors 110 whose environment values meet with the preset condition is provided.

The magnification selecting section 265 selects magnification of images captured by the image capturing apparatus 120 based on the environment value. When the environment values detected by the two or more sensors 110 specified by the sensor combination information generated by the sensor combination identifying information generating section 260 meet with the preset condition, the target image capturing direction deciding section 270 decides a target image capturing direction in which the image capturing apparatus 120 should capture images based on the environment values detected by those sensors 110. The sensor selecting section 275 selects one sensor 110 among the sensors 110 specified by the sensor combination information generated by the sensor combination identifying information generating section 260. The difference information calculating section 280 calculates difference information representing a difference between the target image capturing direction and an image capturing direction of the image capturing apparatus 120 corresponding to the sensor 110 selected by the temperature sensor selecting section 275.

The SNMP control section 285 has a M access control section 287 and a trap control section 289 and implements an agent function in SNMP. The MIB access control section 287 receives au access request to the MIB object stored in the MIB storage section 210 via the TCP/IP control section 295 and carries out a process corresponding to the access request The MIB access control section 287 processes a GetRequest message, GetNextRequest message and SetRequest message based on SNMP for example as such access request. More specifically, the SNMP control section 285 accesses to the NUB object based on the received access request and returns processing results of those access requests to a transmitter of the access request via the TCP/IP control section 295 as an access response such as GetResponse message based on SNMP for example. When the MIB access control section 287 receives SetRequest message or the like instructing changes of the image capturing direction and/or magnification of the image capturing apparatus 120 controlled by the control apparatus 130 here, the MIB access control section 287 informs the image capturing apparatus manipulating section 245 of that instruction.

The trap control section 289 is one exemplary trap control section and message control section of the invention and controls the image capturing direction and magnification of the image capturing apparatus 120 and informs the monitoring apparatus 150 of that the image capturing apparatus 120 should be monitored by transmitting a message such as a trap message based on SNMP for example to the image capturing apparatus 120 and the monitoring apparatus 150 via the TCP/IP control section 295. More specifically, the trap control section 289 transmits an image capturing direction specifying trap message that is one exemplary image capturing direction specifying message for specifying the image capturing direction of the image capturing apparatus 120 based on SNMP, a magnification specifying trap message that is one exemplary magnification specifying message for specifying the magnification of the image capturing apparatus 120 based on SNMP, an image capturing direction difference specifying trap message that is one exemplary image capturing direction difference specifying message containing difference information calculated by the difference information calculating section 280 based on SNMP, an image capturing direction changing trap message that is one exemplary image capturing direction changing message for changing the image capturing direction of the image capturing apparatus 120 based on an instruction of the monitor and the like based on SNMP and a magnification changing trap message that is one exemplary magnification changing message for changing the magnification of the image capturing apparatus 120 based on an instruction of the monitor and the like based on SNMP to the image capturing apparatus 120. Thereby, the trap control section 289 causes the image capturing apparatus 120 to capture images in the image capturing direction specified by the image capturing direction specifying trap message, the image capturing direction difference specifying message and/or the image capturing direction changing message with the magnification specified by the magnification specifying trap message or the magnification changing trap message. The trap control section 289 also transmits an image capturing apparatus specifying trap message specifying the image capturing apparatus 120 to be monitored and a manipulation prohibiting trap message for prohibiting the monitoring apparatus 150, other than the monitoring apparatus 150 that should monitor an abnormality of the external environment when the abnormality is detected, from manipulating the image capturing apparatus 120 to the monitoring apparatus 150. Thereby, the trap control section 289 causes the monitoring apparatus 150 that has received the image capturing apparatus specifying trap message to select and display the images captured by the image capturing apparatus 120 and prohibits the monitoring apparatus 150 that has received the manipulation prohibiting trap message from manipulating the image capturing apparatus 120. The trap control section 289 also transmits an image capturing apparatus selecting trap message that is one exemplary image capturing apparatus selecting message for causing the relay unit 140 to select images to be transmitted to the monitoring apparatus 150 among images captured by the plurality of image capturing apparatuses 120 within the area-under-monitoring 100 to the relay unit 140.

The HTTP control section 290 receives a message based on HTTP and the like instructing manipulation of the image capturing apparatus 120 via the TCP/IP control section 295 and informs the image capturing apparatus manipulating section 245 of that instruction. The TCP/IP control section 295 has functions corresponding to a transport layer, an Internet layer and a network interface layer in a TCP/IP hierarchy model and caries out processes of the transport layer or under in SNMP message communication between the SNMP control section 285 and the relay unit 140 and HTTP message communication between the HTTP control section 290 and the relay unit 140.

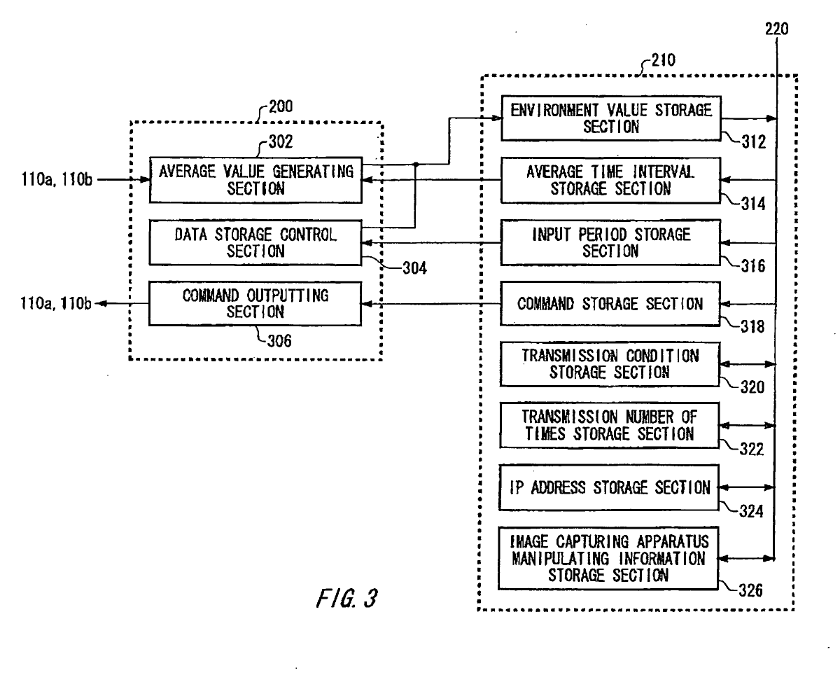

FIG. 3 is a diagram showing one exemplary detail configuration of the environment inputting section 200 and the MIB storage section 210 according to the embodiment of the invention. The environment inputting section 200 has an average value generating section 302, a data storage control section 304 and a command output section 306.

The average value generating section 302 generates an averaged environment value by receiving environment values from each one of the plurality of sensors 110 and by calculating an average value of the environment values. In this case, the average value generating section 302 calculates an average value in time interval set in an average time interval storage section 314.

Here, the average value generating section 302 may generate the environment value through hardware process, In this case, the average value generating section 302 may calculate the average value by receiving the environment values at high sampling rate of every 1 msec. for example. The average time interval storing section 314 may also specify the time intervals for calculating the average value by a number of times of sampling.

The data storage control section 304 stores the environment values in an environment value storage section 312 per period set in an input period storage section 316. The command output section 306 also receives a command from a command storage section 318 and gives it to the sensor 110 to be controlled by the command.

The MIB storage section 210 has the environment value storage section 312, the average time interval storage section 314, an input period storage section 316, the command storage section 318, a transmission condition storage section 320, a number-of-times of transmission storage section 322, an IF address storage section 324 and an image capturing apparatus manipulating information storage section 326. The environment value storage section 312 stores the environment values, the average time interval storage section 314 stores the time interval for calculating an average of the environment values, the input period storage section 316 stores the period for inputting the environment value, the command storage section 318 stores the commands to be given to the sensors 110, the transmission condition storage section 320 stores preset conditions for causing the SNMP control section 285 to transmit a trap message, the number-of-times of transmission storage section 322 stores a number of times for repeatedly transmitting the trap message, the IP address storage section 324 stores IP addresses of the plurality of monitoring apparatuses 150 and the image capturing apparatus manipulating information storage section 326 stores commands accessed by the MIB access control section 287 or the HTTP control section 290 in manipulating the image capturing apparatus 120, respectively in connection with the MIB object.

Here, the MIB storage section 210 obtains and stores an initial value of data to be stored in the MIB storage section 210 from a non-volatile memory and the like connected with the control apparatus 130 in starting the control apparatus 130. Then, receiving a SNMP message of updating information stored in the MIB storage section 210 via the TCP/IP control section 295, the MIB access control section 287 within the SNMP control section 285 updates the information stored in the MIB storage section 210 in accordance to that message. For example, receiving the SNMP message instructing to set the average time interval storage section 314, the MIB access control section 287 sets time intervals specified by the SNMP message in the average time interval storage section 314. Still more, receiving the SNMP message instructing to set the input period storage section 316, the MIB access control section 287 sets the period specified by the SNMP message in the input period storage section 316. Further, receiving the SNMP message conning a command for the sensor 110, the MIB access control section 287 sets the command specified by the SNMP message in the command storage section 318.

The control apparatus 130 may also change the IP address of the monitoring apparatus 150 based on a request from an outside server and the like. In this case, the control apparatus 130 can change the monitoring apparatus to be monitored via the network 160.

In the present embodiment, the MIB storage section 210 stores the command to be given to the sensor 110 and the environment value received from the sensor 110 by correlating with the MIB object. Thereby, the monitoring apparatus 150 can manage the sensor 110 via the MIB object having a data structure set in advance. Therefore, the present embodiment allows the sensor 110 to be adequately managed regardless of types of the sensor 110.

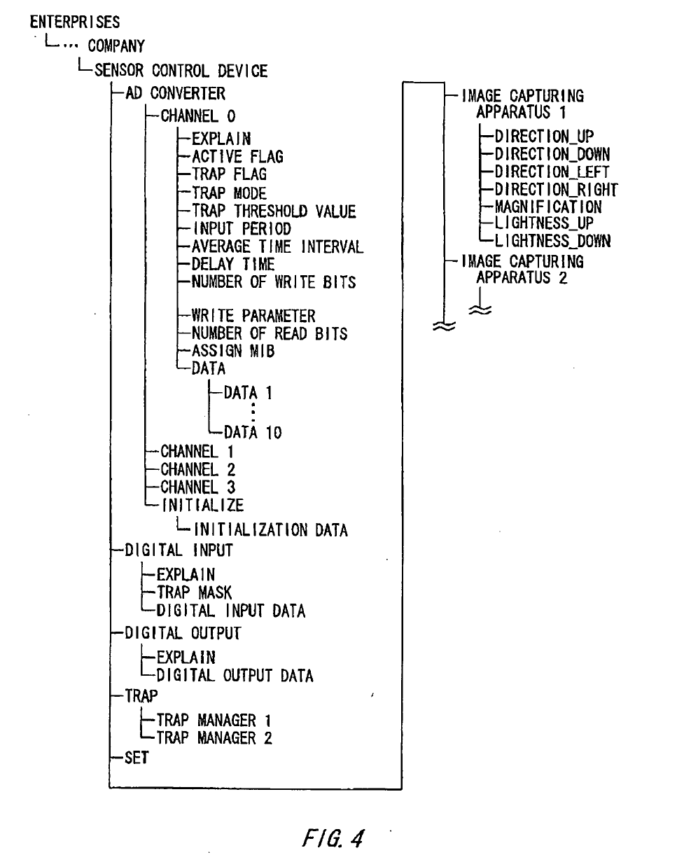

FIG. 4 shows one exemplary configuration of MIB stored in the MB storage section 210 according the embodiment of the invention. In the present embodiment, the MIB storage section 210 stores sub-trees of the control apparatus contained in a sub-tree of . . . company that is a manufacturer of the control apparatus 130 for example defined under enterprises sub-tree (1.3.6.1.4.1). The monitoring apparatus 150 sets values of the MIB objects on and under . . . Company sub-tree by using SNMP message.

It is noted that in the present embodiment, the MIB storage section 210 also stores standard MIB sub-trees (not shown) used in structure control, failure control, performance control, security control, accounting control and others. The monitoring apparatus 150 sets the values of the MID objects on and under those standard MIB sub-trees by using SNMP messages.

Sensor control device sub-tree includes AD converter sub-tree used for controlling the AD converter 205 that converts an environment value inputted from the sensor 110 that outputs an analog signal into a digital value, Digital input sub-tree used for receiving a digital signal from the sensor 110 that inputs/outputs digital signals, Digital output sub-tree used for sending a digital signal to the sensor 110 that inputs/outputs digital signals, Trap sub-tree used for sending a trap message to the monitoring apparatus 150, Preset object and Image capturing apparatus object used for controlling the image capturing apparatus 120.

AD converter sub-tree has Channel 0 through 3 sub-trees each of which corresponds to one analog input terminal of the AD converter 205 and Initialization sub-tree. It is noted that in the present embodiment, the AD converter 205 has four analog input terminals corresponding to Channels 0 through 3. The sensor 110 may supply external input signals to one or the plurality of analog input terminals of the AD converter 205.

Channel 0 sub-tree contains MIB objects respectively representing Explanation, Active flag, Trap flag, Trap mode, Trap threshold value, Input period, Average time interval, Delay time, Number of write bits, Write parameter, Number of read bits and MIB assignment and Data sub-tree.

Explanation object represents information for identifying the name or function of Channel 0 of the AD converter 205. Active flag object represents whether or not Channel 0 is operative. Trap flag object sets whether or not to cause the SNMP control section 285 to transmit a trap message.

Trap mode object represents a number of times when a trap message is repeatedly transmitted. Trap threshold value object represents a threshold value of an environment value as a preset condition. Here, the preset condition judging section 250 judges that the environment value meets with the preset condition when the environment value exceeds the threshold value. Then, the trap control section 289 controls the image capturing apparatus 120 by using the trap message and informs the monitoring apparatus 150 of that the environment value meets with the preset condition. The preset condition judging section 250 and the trap control section 289 may transmit the trap message when environment data changes to a value higher or lower than the threshold value.

Trap threshold value object may also present an upper limit threshold value and a lower limit threshold value as the threshold value. In this case, the preset condition judging section 250 and the trap control section 289 may transmit the trap message when the environment value changes to a value higher than the upper limit threshold value or a value lower than the lower limit threshold value.

Input period object represents a period for storing a new environment value to the environment value storage section 312. Average time interval object represents a time interval for averaging the output of the AD converter 205. Delay time object represents a delay time until when the AD converter 205 outputs data in response to an output of a command to the AD converter 205. Number of write bits object represents a bit length of a command or setting parameter given to the AD converter 205. Write parameter object represents a command or setting parameter given to the AD converter 205. Number of read bits object represents a bit length of digital data received from the AD converter 205.

MIB assignment object represents assignment of Channel 0, i.e., a physical channel, to logical channel. Here, the monitoring apparatus 150 specifies the logical channel to access to the control apparatus 130 and the MIB access control section 287 within the control apparatus 130 accesses to the physical channel of the AD converter 205 corresponding to that logical channel.

Data sub-tree contains MIB objects of Data 1 through 10. Data 1 through 10 objects present environment values received respectively from the AD converter 205. It is noted that explanation of Channel 1 through 3 sub-trees will be omitted here because each has the same or similar configuration with Channel 0 sub-tree.

Initialization sub-tree contains Initialization data object representing a command or setting parameter for initializing the AD converter 205. Initialization data object represents a gain, offset or the like to be set in the AD converter 205.

Digital input sub-tree contains MIB objects respectively representing Explanation, Trap mask and Digital input data. Explanation object represents information for identifying the name representing a digital signal or the type of the digital signal received by the control apparatus 130 from the sensor 110 via a digital signal line. Trap mask object is used to select bits used in detecting a condition for transmitting a trap signal within the digital signal. Digital input data object represents a value of a digital signal received from the sensor 20.

Digital output tree contains MM objects respectively representing Explanation and Digital output data. Explanation object represents a name representing a command or data that is a digital signal given from the control apparatus 130 to the sensor 110 via the digital signal line or information for identifying a format of communication via the digital signal line. Digital output data object is used to write a digital signal given to the sensor 110 via the digital signal line.

Trap sub-tree contains MIB objects respectively representing Trap manager 1 and 2. Trap manager 1 object represents IP address of the monitoring apparatus 150a. Trap manager 2 object represents IP address of the monitoring apparatus 150b.

Setting object is a NIB object used to update an initial value of storage contents of the Mm storage section 210. The monitoring apparatus 150 updates the initial value of the storage contents stored in the MIB storage section 210 by setting a value in Setting object to restart the control apparatus 130.

Image capturing apparatus 1 sub-tree contains MIB objects representing commands for changing an image capturing direction, magnification and lightness of the image capturing apparatus 120a. When a value is written in Direction (Up, Down, Left and Right) objects by the monitoring apparatus 150 and others, the image capturing apparatus manipulating section 245 changes the image capturing direction of the image capturing apparatus 120a in a direction corresponding to that Direction object. Still more, when a value is written in Magnification object by the monitoring apparatus 150 and others, the image capturing apparatus manipulating section 245 changes the magnification of the image capturing apparatus 120a corresponding to the value written in that Magnification object. When a value is written in Lightness (Up, Down) object by the monitoring apparatus 150 and others, the image capturing apparatus manipulating section 245 changes the lightness of the captured image corresponding to that Lightness object. Image capturing apparatus 2 sub-tree has the similar function and configuration with Image capturing apparatus 1 sub-tree and contains MIB objects representing commands for changing an image capturing direction, magnification and lightness of the image capturing apparatus 120b.

The MIB objects other than the MIB object representing the input data received from the sensor 110 via the AD converter 205 may be re-writable by the monitoring apparatus 150 and others. It allows a user of the control apparatus 130 to make setting and others of the sensor 110, the image capturing apparatus 120 and the control apparatus 130 via the network 160.

In the present embodiment, the environment value storage section 312 stores values of Data 1 through 10 objects. The average time interval storage section 314 stores a value of Average time interval object. The input period storage section 316 stores a value of Input period object. The command storage section 318 stores a value of Digital output data object. The transmission condition storage section 320 stores values of Trap flag object and Trap threshold value object. The number-of-times of transmission storage section 322 stores a value of Trap mode object. The IP address storage section 324 stores values of Trap manager 1 and 2 objects. The image capturing apparatus manipulating information storage section 326 stores values of Image capturing apparatus 1 and 2 objects.

Thereby, the MIB storage section 210 stores environment values by correlating with Data 1 through 10 objects (Input data MIB objects) independent of the type of the sensor 110 and stores a command given to the sensor 110 by correlating with Digital output data object (Command MB object) independent of the type of the sensor 110. Then, the control apparatus 130 transmits a trap message to the network 160 via the relay unit 140 based on the environment values correlated with Data 1 through 10 objects. Still more, the command output section 306 gives the command correlated with Digital output data object to the sensor 110. According to the present embodiment, the control apparatus 130 can provide the monitoring apparatus 150 with the interface for managing the various sensors 110 by SNMP by using MIB having a general structure independent of the type of the sensor 110. It also allows different types of device-under-control to be managed by one and same hardware process.

The MIB storage section 210 within the control apparatus 130 described above may store the MIB trees or MIB sub-trees exemplified in FIG. 4 separately corresponding to each of the plurality of monitoring apparatuses 150. Then, when the MIB access control section 287 receives a request for accessing to the MIB storage section 210, it may allow the access to the MIB objects belonging to the MIB trees or MID sub-trees corresponding to the monitoring apparatus 150 that has transmitted the access request among the MIB objects stored in the MIB storage section 210. Still more, when the MIB access control section 287 receives an add request of adding a MIB object anew to the MIB trees or MIB sub-trees stored corresponding to the monitoring apparatus 150 from the plurality of monitoring apparatuses 150 or when it receives a delete request of deleting a MIB object from the MIB trees or MIB sub-tees, the MIB access control section 287 may add or delete the MIB object to/from the MIB trees or MIB sub-trees stored corresponding to the monitoring apparatus 150 in response to the request.

It enables the control apparatus 130 to flexibly change the configuration of the MIB trees or MIB sub-trees stored in the MIB storage section 210 corresponding to monitoring processes that are different per each of the plurality of monitoring apparatuses 150 and to effectively realize a plurality of monitoring services provided by companies and others different from each other.

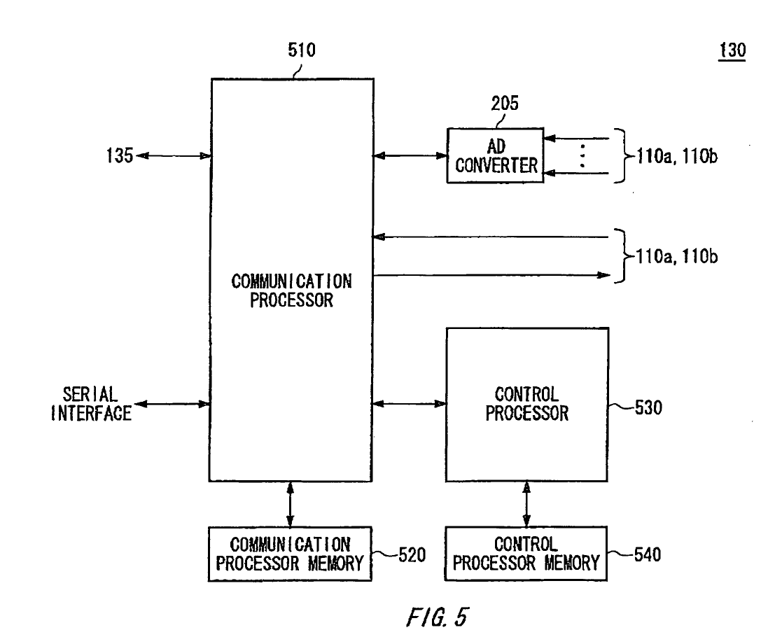

FIG. 5 is a diagram showing one exemplary hardware configuration of the control apparatus 130 according the embodiment of the invention. The control apparatus 130 has the AD converter 205, a communication processor 510, a communication processor memory 520, a control processor 530 and a control processor memory 540.

The communication processor 510 realizes functions of the environment inputting section 200 except of that of the AD converter 205, functions of the SNMP control section 285, functions of the HTTP control section 290 and functions of the TCP/IP control section 295 by hardware logic for example. The communication processor 510 has a digital interface that connects the plurality of sensors 110, a network interface connected with the communication network 135 and a serial interface used for managing the communication processor 510 and is also connected with the communication processor memory 520 and the control processor 530. Here, the communication processor 510 is connected with the sensor 110 that outputs a digital signal via the digital interface. The communication processor 510 is also connected with the sensor 110 that outputs an analog signal via the AD converter 205 connected with the digital interface.

The communication processor memory 520 stores firmware and the like used by the MIB storage section 210 and the communication processor 510. The control processor 530 realizes the functions of the application processing section 240 by processing a program. The control processor memory 540 stores a program that operates on the sensor correlated information storage section 230 and the control processor 530. The control processor memory 540 realizes functions of each member within the application processing section 240 by a script program in the present embodiment.

The communication processor 510 and the control processor 530 described above may be installed on different semiconductor chips or may be installed on one semiconductor chip.

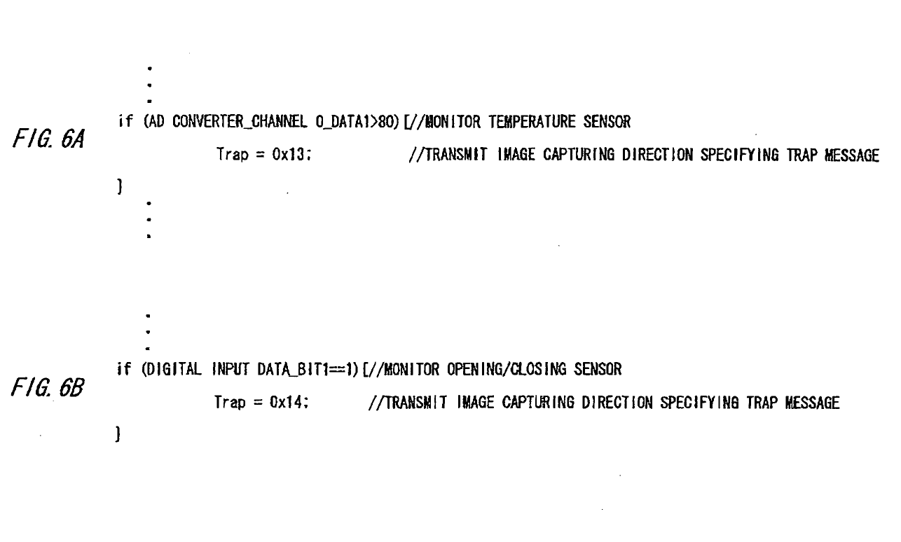

FIGS. 6A and 6B show an exemplary script executed in the control processor 530 according to the embodiment of the invention. Scripts illustrated in FIG. 6 are programs that cause the control processor 530 to function as the image capturing apparatus manipulating section 245, the preset condition judging section 250, the image capturing apparatus identifying information selecting section 255, the sensor combination identifying information generating section 260, the magnification selecting section 265, the target image capturing direction deciding section 270, the temperature sensor selecting section 275 and the difference information calculating section 280 within the application processing section 240.

FIG. 6A shows a first exemplary script. The first script causes the control apparatus 130 to monitor the analog temperature sensor 110 and when the temperature sensor detects abnormal temperature, to operate so that the image capturing apparatus 120 captures images in the neighborhood of the location where the temperature sensor is set. The first script stipulates a preset condition that “environment value exceeds 80” corresponding to the temperature sensor, i.e., that the detected temperature exceeds 80 degrees.

The control processor 530 functions as the preset condition judging section 250 for judging the preset condition by executing the first script. More specifically, the control processor 530 reads the environment value of the temperature sensor inputted from the sensor 110 via the AD converter 205 and stored in the communication processor memory 520 as a MIB object via the communication processor 510 and judges whether or not the read environment value meets with the preset condition. When the environment value inputted from the temperature sensor meets with the preset condition, the control processor 530 executes “trap=0x13” and instructs the trap control section 289 within the communication processor 510 to transmit a trap message whose trap type is sensor identifying information 0x13 identifying the temperature sensor. Thus, the control processor 530 instructs to transmit the trap message containing the sensor identifying information corresponding to the sensor 110 that has detected the environment value meeting with the preset condition in the trap type.

Receiving the instruction from the control processor 530, the trap control section 289 within the communication processor 510 transmits the image capturing direction specifying trap message containing the sensor identifying information of the temperature sensor in the trap type to the image capturing apparatus 120 corresponding to the sensor 110.

FIG. 6B shows a second exemplary script. The second script causes the control apparatus 130 to monitor the digital opening sensor 110 and when the opening sensor detects that a door or the like is opened, to operate so that the image capturing apparatus 120 captures images in the neighborhood of the location where the opening sensor is set. The second script stipulates a preset condition representing that “environment value is 1” corresponding to the opening sensor, i.e., that the door or the like is opened.

The control processor 530 functions as the preset condition judging section 250 for judging the preset condition by executing the second script. More specifically, the control processor 530 reads the environment value of the opening sensor inputted from the sensor 110 and stored in the communication processor memory 520 as a object via the communication processor 510 and judges whether or not the read environment value meets with the preset condition. When the environment value inputted from the opening sensor meets with the preset condition, the control processor 530 executes “trap=0x14” and instructs the trap control section 289 within the communication processor 510 to transmit a trap message whose a trap type is sensor identifying information 0x14 identifying the opening sensor.

Receiving the instruction from the control processor 530, the trap control section 289 within the communication processor 510 transmits the image capturing direction specifying trap message containing the sensor identifying information of the opening sensor as its trap type to the image capturing apparatus 120 corresponding to the sensor 110.

The use of the scripts described above enables the control apparatus 130 to monitor the sensor 110 based on a more complicated preset condition as compared to preset conditions stored in the transmission condition storage section 320 and others.

It is noted that the control apparatus 130 may store preset conditions corresponding to the plurality of sensors 110 in the communication processor memory 520 as scripts described above and may execute corresponding to each one of the plurality of monitoring apparatuses 150. Tat is, the control apparatus 130 may control the image capturing apparatus 120 so that the monitoring apparatus 150a monitors when environment values inputted from the plurality of sensors 110 meet with a preset condition stipulated by a first script and may control the image capturing apparatus 120 so that the monitoring apparatus 150b monitors when the environment values inputted from the plurality of sensors 110 meet with a preset condition stipulated by a second script by executing the first script corresponding to the monitoring apparatus 150a and the second script corresponding to the monitoring apparatus 150b in parallel. That is, the control apparatus 130 enables different groups, companies or the like to monitor the area-under-monitoring 100 independently by executing scripts, in parallel, separately prepared by the different groups, companies or the like such as disaster prevention centers and guarding companies.

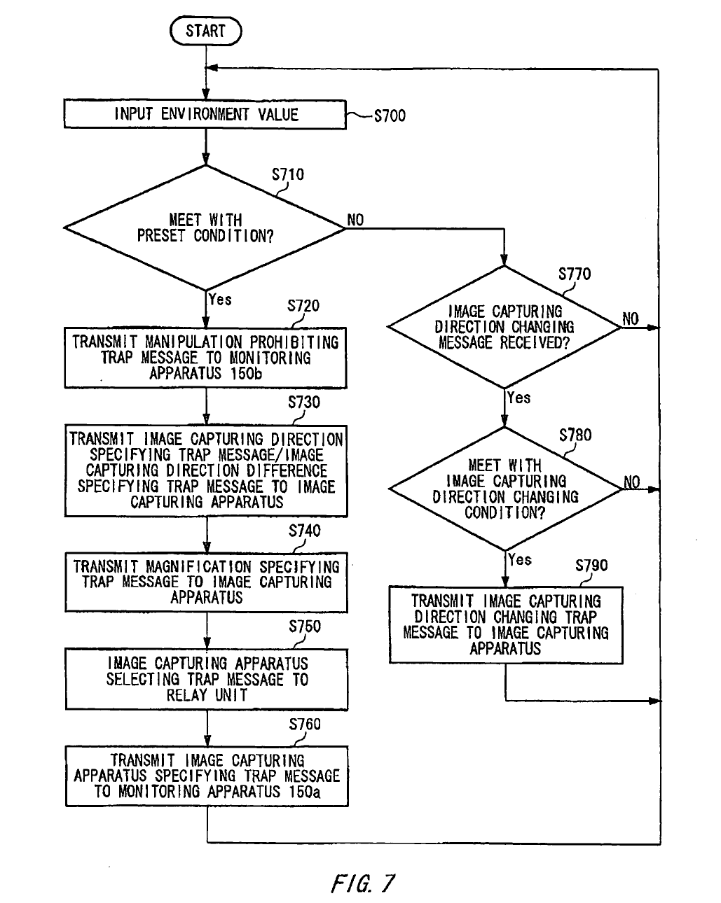

FIG. 7 shows an operation flow of the control apparatus 130 according to the embodiment of the invention.

At first, the control apparatus 130 receives an environment value representing external environment at the location where the sensor 110 is set through the environment inputting section 200 from the plurality of sensors 110 and stores it in the MIB storage section 210 in Step S700. Next, the preset condition judging section 250 judges whether or not the environment value inputted from the sensor 110 meets with a preset condition set in advance corresponding to the sensor 110 for each of the plurality of sensors 110 and generates sensor identifying information for identifying the sensor 110 when the preset condition is met in Step S710. In the same manner, the sensor combination identifying information generating section 260 judges whether or not the environment values of the two or more sensors 110 meets with the preset condition set in advance and generates sensor combination identifying information for identifying the two or more sensors 110 when they meet with the preset condition in Step S710. Here, a case when the preset condition described above is a preset condition set in correspondence to the monitoring apparatus 150a will be explained in the present embodiment.

When the environment value inputted from one or the plurality of sensors 110 meet with the preset condition (Yes in S710), the trap control section 289 transmits a manipulation prohibiting trap message representing that no instruction of changing the image capturing direction in which the image capturing apparatus 120 corresponding to that sensor 110 is capturing images will be accepted from the monitoring apparatus 150b to the monitoring apparatus 150b via the TCP/IP control section 295, the relay unit 140 and the network 160 in Step S720.

Receiving the manipulation prohibiting trap message, the monitoring apparatus 150b inhibits the manager of the monitoring apparatus 150b from changing the image capturing direction of the image capturing apparatus 120 for a period of time set in advance. Here, when the monitoring apparatus 150b receives the manipulation prohibiting trap message while displaying an image captured by the image capturing apparatus 120, it may display the image captured by the image capturing apparatus 120 before receiving the manipulation prohibiting trap message for a period of time set in advance.

Next, the trap control section 289 transmits an image capturing direction specifying trap message instructing to capture images in an image capturing direction set in advance corresponding to one or the plurality of sensors 110 that has inputted the environment value meeting with the preset condition to the image capturing apparatus 120 corresponding to image capturing apparatus identifying information selected by the image capturing apparatus identifying information selecting section 255 via the communication network 135 in Step S730. Here, the trap control section 289 may transmit an image capturing direction specifying trap message containing sensor identifying information for identifying the sensor 110 as a trap type for example to the image capturing apparatus 120 or may transmit an image capturing direction specifying trap message containing sensor combination identifying information for identifying a combination of two or more sensors 110 as a trap type for example to the image capturing apparatus 120.

Here, when the environment values detected by two or more sensors 110 meet with the preset condition corresponding to the sensors 110, the target image capturing direction deciding section 270, the temperature sensor selecting section 275 and the difference information calculating section 280 within the application processing section 240 and the trap control section 289 may specify the image capturing direction in which the image capturing apparatus 120 captures images based on the environment values detected by those sensors. More specifically, when each of the plurality of sensors 110 is a temperature sensor for detecting temperature at the location where the sensor 110 is set, the target image capturing direction deciding section 270, the temperature sensor selecting section 275 and the difference information calculating section 280 within the application processing section 240 and the trap control section 289 perform the following processes.

At first, when temperature detected respectively by each two or more temperature sensors exceeds preset temperature set as a preset condition for the temperature sensor, the target image capturing direction deciding section 270 decides a target image capturing direction in which the image capturing apparatus 120 should capture images based on the temperature detected respectively by the two or more temperature sensors detecting the temperature exceeding the preset temperature. Here, the target image capturing direction deciding section 270 may decide the target image capturing direction so that the image capturing apparatus 120 captures images centering on a spot where the temperature is higher than its peripheral area for example by calculating a temperature distribution within the area-under-monitoring 100 based on the temperature detected respectively by the two or more temperature sensors.

Next, the temperature sensor selecting section 275 selects one temperature sensor that has detected the temperature exceeding the preset temperature set as the preset condition. Here, the temperature sensor selecting section 275 may select a temperature sensor located in a direction closest to the target image capturing direction from the aspect of the image capturing apparatus 120 or instead may select a temperature sensor that has detected the highest temperature fox example among the temperature sensors that have detected the temperature exceeding the preset temperature.

Next, the difference information calculating section 280 calculates difference information representing a difference between the target image capturing direction and an image capturing direction defined corresponding to one temperature sensor selected by the temperature sensor selecting section 275. Here, the image capturing direction defined corresponding to the sensor 110 is an image capturing direction in which the image capturing apparatus 120 should capture images when the environment value inputted from the sensor 110 meets with the preset condition.

Then, the trap control section 289 transmits the image capturing direction specifying trap message containing the sensor identifying information of one temperature sensor selected by the temperature sensor selecting section 275 and the image capturing direction difference specifying trap message containing the difference information to the image capturing apparatus 120 specified by the image capturing apparatus identifying information selecting section 255 via the communication network 135. It enables the control apparatus 130 to define the target image capturing direction based on the environment values detected by those sensors 110, to direct the image capturing apparatus 120 in the image capturing direction corresponding to the sensor 110 located in the vicinity of the target image capturing direction and then to change the direction of the image capturing apparatus 120 in the target image capturing direction based on the difference information when the environment values detected respectively by the two or more sensors 110 meet with the preset condition corresponding to the sensor 110.

Next, the magnification selecting section 265 selects magnification of the image captured by the image capturing apparatus 120 based on the environment value and the trap control section 289 transmits a magnification specifying trap message containing the selected magnification as a trap type for example to the image capturing apparatus 120 selected by the image capturing apparatus identifying information selecting section 255 via the communication network 135 in Step S740. Here, when the sensor 110 that has detected the environment value meeting with the preset condition is a temperature sensor for detecting temperature at the location where the sensor 110 is set and when the temperature detected by the temperature sensor is higher, the magnification selecting section 265 selects lower magnification as compared to a case when the temperature is low. Thereby, the magnification selecting section 265 can cause the image capturing apparatus 120 to capture an image of a wide range when the temperature detected by the temperature sensor is high and it is judged that fire or the like is spreading in a wide range.

Next, the trap control section 289 transmits an image capturing apparatus selecting trap message containing image capturing apparatus identifying information selected by the image capturing apparatus identifying information selecting section 255 to the relay unit 140 via the communication network 135 in Step S750. Receiving that, the relay unit 140 selects an image captured by the image capturing apparatus 120 specified by the image capturing apparatus identifying information contained in the image capturing apparatus selecting trap message as an image to be displayed on the monitoring apparatus 150a and transmits the image to the monitoring apparatus 150a It permits the relay unit 140 to transmit the image to be monitored on the monitoring apparatus 150a among images captured within the area-under-monitoring 100, a traffic volume of image data to be transmitted to the network 160 to be reduced and the monitor to omit a manipulation for selecting the image capturing apparatus 120 to be monitored.

Next, the trap control section 289 transmits an image capturing apparatus specifying a message containing image capturing apparatus identifying information for identifying the image capturing apparatus 120 controlled by the control apparatus 130 having the trap control section 289 to the monitoring apparatus 150a in Step S760. Receiving the message, the monitoring apparatus 150a selects and displays for the monitor the image captured by the image capturing apparatus 120 specified by the image capturing apparatus identifying information contained in the image capturing apparatus specifying trap message among the plurality of images captured respectively the plurality of image capturing apparatuses 120. Thereby, the monitoring apparatus 150 can adequately select the image capturing apparatus 120 specified by the image capturing apparatus identifying information contained in the received image capturing apparatus specifying trap message and can display the image captured by the image capturing apparatus 120, so that the monitor can quickly monitor the neighborhood of the sensor 110 when either one of the sensors 110 detects an abnormality or the like.

Here, when the monitoring apparatus 150a receives a plurality of image capturing apparatus specifying trap messages from one or a plurality of control apparatuses 130 within a period of time set in advance, the monitoring apparatus 150a may display an image captured by the image capturing apparatus 120 specified by first image capturing apparatus identifying information contained in the first image capturing apparatus specifying trap message and an image captured by the image capturing apparatus 120 specified by second image capturing apparatus identifying information contained in the second image capturing apparatus specifying trap message in the same time or may also display one image by video and display another image by a still image. Instead of that, the monitoring apparatus 150a may display the image captured by the image capturing apparatus 120 specified by the first image capturing apparatus identifying information and the image captured by the image capturing apparatus 120 specified by the second image capturing apparatus identifying information while switching them per period set in advance for example.

When the environment value inputted from the sensor 110 in Step S710 does not meet with the preset condition on the other hand (No in Step S710), the image capturing apparatus manipulating section 245 judges whether or not the control apparatus 130 has received an image capturing direction changing request message from the monitoring apparatus 150a or 150b via the MIB access control section 287 or the HTTP control section 290. When no image capturing direction changing request message has been received (No in Step S770), the control apparatus 130 advances the process to Step S700.

Receiving the image capturing direction changing request message or the magnification changing request message, the image capturing apparatus manipulating section 245 judges whether or not a condition that allows the change of the image capturing direction or magnification is met in Step S780. More specifically, the image capturing apparatus manipulating section 245 judges that the image capturing direction or magnification may be changed when the control apparatus 130 detects an abnormality or the like in the environment value of the sensors 110 and transmits the image capturing apparatus specifying trap message to the monitoring apparatus 150a and when it receives an image capturing direction changing request message from the monitoring apparatus 150a that should monitor the vicinity of the sensor 110 or when it receives an image capturing direction changing request message or the magnification changing request message from the monitoring apparatus 150b in a state in which the image capturing direction specifying trap message has not transmitted to the other monitoring apparatus 150 for a period of time set in advance. When this condition is met, the trap control section 289 receives an instruction from the image capturing apparatus manipulating section 245 and transmits an image capturing direction changing trap message or a magnification changing trap message that instructs to change the image capturing direction or the magnification of the image capturing apparatus 120 to be manipulated by the image capturing direction changing request message or the magnification changing request message to a direction or magnification specified by the image capturing direction changing request message or the magnification changing request message to the image capturing apparatus 120 in Step S790. It prevents the monitoring apparatuses 150 other than the monitoring apparatus 150 that should monitor an abnormality or the like when the environment value inputted from the sensor 110 is abnormal from manipulating the image capturing apparatus 120 and the detection of the abnormality from becoming late.

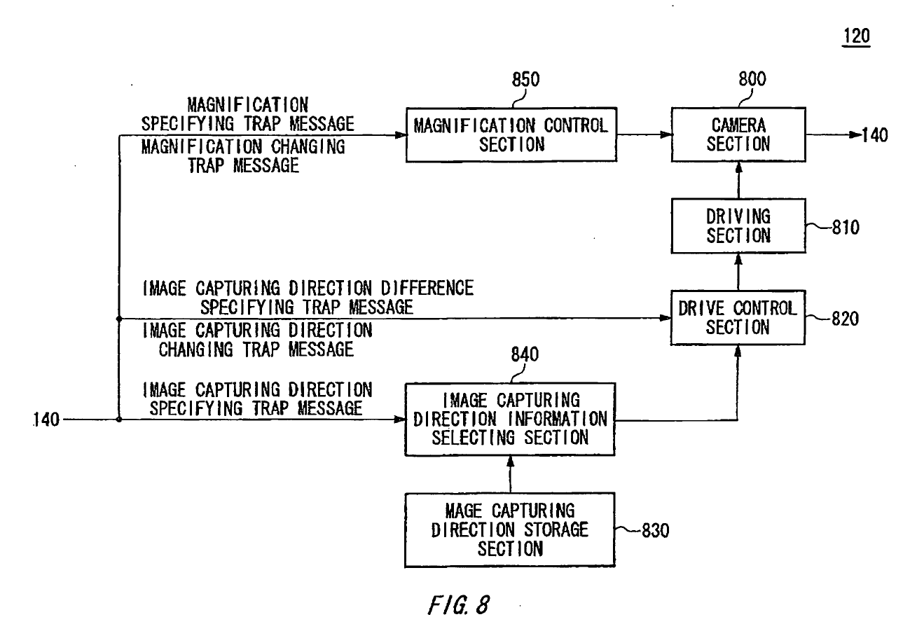

FIG. 8 shows a configuration of the image capturing apparatus 120 according the embodiment of the invention. The image capturing apparatus 120 has a camera section 800, a driving section 810, a driving control section 820, an image capturing direction storage section 830, an image capturing direction information selecting section 840 and a magnification control section 850. The camera section 800 captures an image i.e. a still image or a video image, and transmits it to the communication network 135. The driving section 810 changes an image capturing direction of the camera section 800 by turning the direction of the camera section 800 in horizontal and vertical directions. The driving control section 820 controls the driving section 810 to direct the camera section 800 in an image capturing direction specified by the image capturing direction specifying trap message, image capturing direction difference specifying trap message and image capturing direction changing trap message received from the control apparatus 130 to cause the camera section 800 to capture images in the image capturing direction.

The image capturing direction storage section 830 stores sensor identifying information for identifying the sensors 110 and image capturing direction information representing the image capturing direction in which the camera section 800 should capture images when the environment value inputted from the sensor 110 meets with the preset condition for each of the plurality of sensors 110 to be monitored by the image capturing apparatus 120. The image capturing direction storage section 830 also stores sensor combination identifying information and image capturing direction information representing the image capturing direction in which the camera section 800 should capture images when the environment values of two or more sensors 110 contained in the combination of the sensors 110 identified by the sensor combination identifying information meet with the preset condition. The image capturing direction information selecting section 840 selects image capturing direction information corresponding to the sensor identifying information and/or sensor combination identifying information contained in the image capturing direction specifying trap message received via the communication network 135 out of the image capturing direction storage section 830 and supplies it to the driving control section 820 to direct the camera section 800 in the image capturing direction specified by the image capturing direction information. The magnification control section 850 sets the magnification of an image captured by the camera section 800 to the magnification contained in the magnification specifying trap message received via the communication network 135 by changing a value of zoom for example.

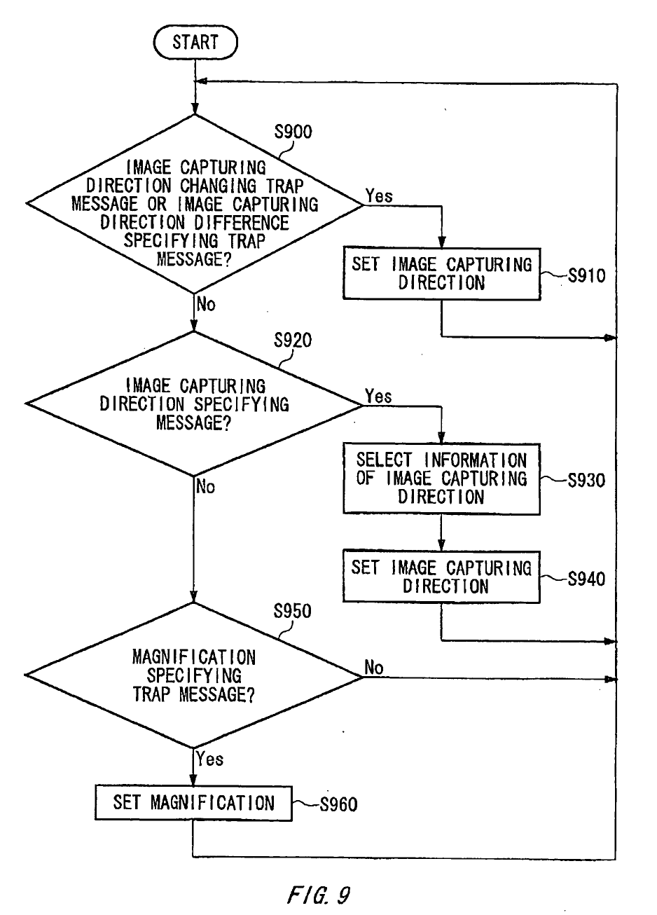

FIG. 9 shows an operation flow of the image capturing apparatus 120 according the embodiment of the invention.

When the image capturing apparatus 120 receives an image capturing direction changing trap message in Step S900, the driving control section 820 of the image capturing apparatus 120 controls the driving section 810 to direct the camera section 800 in an image capturing direction specified by the image capturing direction changing trap message in Step S910. When the image capturing apparatus 120 receives a magnification changing trap message, the magnification control section 850 of the image capturing apparatus 120 may control the camera section 800 to set its magnification to magnification specified by the magnification changing trap message in Step S910.

When the image capturing apparatus 120 receives an image capturing direction specifying trap message in Step S920, it selects image capturing direction information corresponding to sensor identifying information and/or sensor combination identifying information contained in the received image capturing direction specifying trap message out of the image capturing direction storage section 830 in Step S930. The driving control section 820 controls the driving section 810 based on the image capturing direction information selected by the image capturing direction information selecting section 840 to direct the camera section 800 in the image capturing direction defined by the image capturing direction information and to cause the camera section 800 to capture images in the image capturing direction in Step S940.

When the image capturing apparatus 120 receives a magnification specifying trap message in Step S950, the magnification control section 850 sets magnification of an image captured by the camera section 800 at the magnification contained in the magnification trap message received via the communication network 135 in Step S960.

When the image capturing apparatus 120 sequentially receives the image capturing direction specifying trap message and the image capturing direction difference specifying trap message in the process described above, the driving control section 820 controls the driving section 810 based on the image capturing direction information corresponding to the sensor identifying information of one sensor 110 contained in the image capturing direction specifying trap message in Step S940 and then controls the driving section 810 based on difference information contained in the image capturing direction difference specifying trap message in Step S910. It allows the driving control section 820 to direct the camera section 800 in the target image capturing direction and to cause the camera section 800 to capture images in the image capturing direction.

According to the image capturing apparatus 120 described above, the control apparatus 130 can control the image capturing apparatus 120 by transmitting the image capturing direction specifying trap message, the image capturing direction difference specifying trap message, the image capturing direction changing trap message and the magnification specifying trap message.

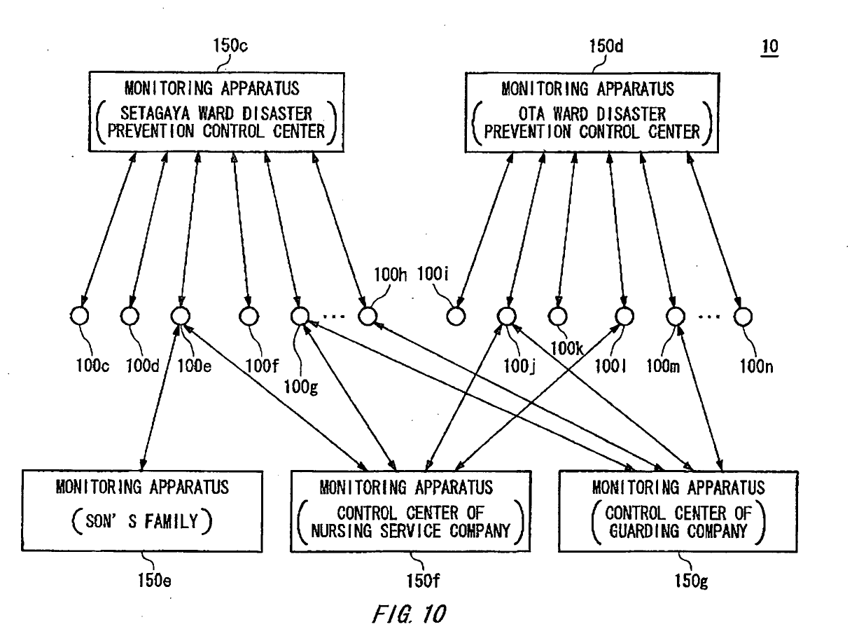

FIG. 10 shows another configuration of the monitoring system 10 according to the embodiment of the invention. The monitoring system 10 of the present embodiment has a plurality of areas-under-monitoring 100 and a plurality of monitoring apparatuses 150. The areas-under-monitoring 100c through 100h are houses and others located in a first region such as Setagaya Ward and have the similar configuration with the area-under-monitoring 100a shown in FIG. 1. The areas-under-monitoring 100i through 100n are houses and others located in a second region such as Ota Ward and have the similar configuration with the area-under-monitoring 100a.

The monitoring apparatuses 150c through 150g have the similar configuration with the monitoring apparatus 150 shown in FIG. 1. The monitoring apparatuses 150c through 150g are managed by different groups and companies in the present embodiment. More specifically, the monitoring apparatus 150c is provided in a disaster prevention control center in the first region to monitor fires and others in the first region. The monitoring apparatus 150d is provided in a disaster prevention control center in the second region to monitor fires and others in the second region. The monitoring apparatus 150c is provided in a son's home to monitor state of affairs of a parent's household living in the area-under-monitoring 100e. The monitoring apparatus 150f is provided in a nursing service company that provides nursing services to monitor state of affairs of members of the nursing services living in the areas-under-monitoring 100e, 100g, 100j and 100l. The monitoring apparatus 150g is provided in a guard company to monitor whether or not trespass and others occur in the areas-under-monitoring 100g, 100h, 100j and 100m where members of crime prevention services live.

The control apparatus 130 in each of the plurality of areas-under-monitoring 100 performs the above-mentioned processes based on different preset conditions for one or each of the plurality of monitoring apparatuses 150 monitoring the pertinent area-under-monitoring 100. That is, for each of the plurality of monitoring apparatuses 150, the control apparatus 130 transmits an image capturing direction specifying trap message and others instructing to capture images in an image capturing direction corresponding to the sensor 110 to the image capturing apparatus 120 controlled by the control apparatus 130 via the communication network 135 when an environment value inputted from the sensors 110 connected to the control apparatus 130 meets with the preset condition corresponding to the monitoring apparatus 150 and the sensor 110. The control apparatus 130 also transmits an image capturing apparatus specifying trap message and others containing image capturing apparatus identifying information for identifying the image capturing apparatus 120 controlled by the control apparatus 130 to the monitoring apparatuses 150a and 150b.

Receiving these trap messages, each of the plurality of monitoring apparatuses 150 selects and displays an image captured by the image capturing apparatus 120 specified by the image capturing apparatus identifying information contained in the image capturing apparatus specking trap message among a plurality of images captured respectively by the plurality of image capturing apparatuses 120.

Here, the control apparatus 130 can monitor each sensor 110 based on the preset condition defined separately by the respective groups and companies by executing the scripts exemplified in FIG. 6 and separately prepared by the different groups and companies in parallel. Thereby, the control apparatus 130 enables the different groups and companies to independently monitor the area-under-monitoring 100.

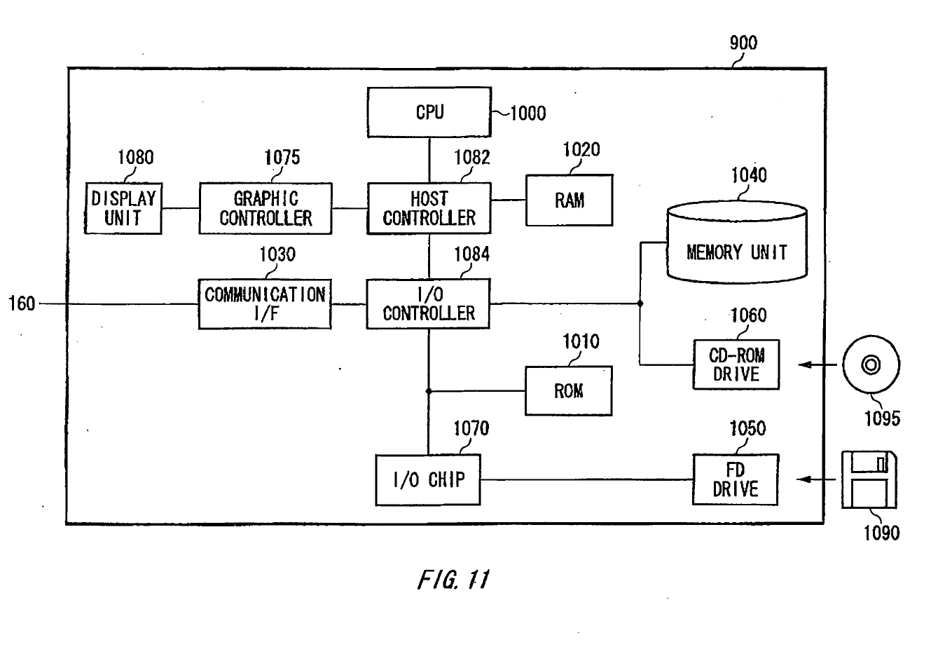

FIG. 11 shows a configuration of a computer 900 according to the embodiment of the invention. The computer 900 of the present embodiment functions as the monitoring apparatus 150 by executing a monitoring program. The computer 900 has a CPU peripheral section including a CPU 1000, a RAM 1020, a graphic controller 1075 and a display unit 1080 mutually connected via a host controller 1082, an input/output section including a communication interface 1030, a storage unit 1040 and a CD-ROM drive 1060 connected to the host controller 1082 via an input/output controller 1084 and a legacy input/output section including a ROM 1010, a flexible disk drive 1050 and an input/output chip 1070 connected to the input/output controller 1084.

The host controller 1082 connects the RAM 1020 with the CPU 1000 and the graphic controller 1075 that access to the RAM 1020 at high transfer rate. The CPU 1000 operates based on programs stored in the ROM 1010 and the RAM 1020 and controls the respective sections. The graphic controller 1075 obtains image data generated by the CPU 1000 and others on a frame buffer provided within the RAM 1020 to display on the display unit 1080. Instead of that, the graphic controller 1075 may contain a frame buffer for storing image data generated by the CPU 1000 and others.

The input/output controller 1084 connects the host controller 1082 with the communication interface 1030, the storage unit 1040 and the CD-ROM drive 1060 that are relatively high speed input/output devices. The communication interface 1030 communicates with other apparatuses via network. The storage unit 1040 stores programs and data used by the CPU 1000 within the computer 900. The CD-ROM drive 1060 reads a program or data from a CD-ROM 1095 and provides it to the storage unit 1040 via the RAM 1020.

The input/output controller 1084 is connected also with relatively low speed input/output devices such as the ROM 1010, the flexible disk drive 1050 and the input/output chip 1070. The ROM 1010 stores boot programs executed in starting the computer 900 and programs dependent on hardware of the computer 900. The flexible disk drive 1050 reads programs or data from a flexible disk 1090 and provides it to the storage unit 1040 via the RAM 1020. The input/output chip 1070 is connected with various input/output devices via the flexible disk drive 1050, a parallel port, a serial port, a keyboard port, a mouse port and the like.

A user provides a program stored in a recording medium such as the flexible disk 1090, the CD-ROM 1095, an IC card or the like to the storage unit 1040 via the RAM 1020. A monitoring program for operating the computer 900 as the monitoring apparatus 150 is read out of the recording medium, is installed in the storage unit 1040 within the computer 900 via the RAM 1020 and is executed in the CPU 1000. An image capturing apparatus program for controlling the image capturing apparatus 120 is read out of the recording medium, is installed in the image capturing apparatus 120 via the communication interface 1030 and the network 160 and is executed in the image capturing apparatus 120. A control apparatus program for controlling the control apparatus 130 is read out of the recording medium, is installed in the control apparatus 130 via the communication interface 1030 and the network 160 and is executed in the control apparatus 130.

The image capturing apparatus program installed in the image capturing apparatus 120 has a drive control module, an image capturing direction information selecting module and a magnification control module. These programs and modules operate the image capturing apparatus 120 as the driving control section 820, the image capturing direction information selecting section 840 and the magnification control section 850, respectively,

The control apparatus program installed in the control apparatus 130 has an application processing module having an environment inputting module, an image capturing apparatus manipulating module, a preset condition judging module, an image capturing apparatus identifying information selecting module, a sensor combination identifying information generating module, a magnification selecting module, a target image capturing direction deciding module, a temperature sensor selecting module and a difference information calculating module, au SNMP controlling module having a MIB access controlling module and a trap controlling module, a HTTP controlling module and a TCP/IP controlling module. These programs and modules operate the control apparatus 130 as the application processing section 240 having the image capturing apparatus manipulating section 245, the preset condition judging section 250, the image capturing apparatus identifying information selecting section 255, the sensor combination identifying information generating section 260, the magnification selecting section 265, the target image capturing direction deciding section 270, the temperature sensor selecting section 275 and the difference information calculating section 280, the SNMP control section 285 having the MM access control section 287 and the trap control section 289, the HTTP control section 290 and the TCP/IP control section 295, respectively.

The programs and modules described above may be stored in eternal recording media. As the recording media, an optical recording medium such as DVD and PD, a magneto-optical recording medium such as MD, a taped medium, a semiconductor memory such as IC card and the like may be used beside the flexible disk 1090 and the CD-ROM 1095. It is also possible to use a storage unit such as a hard disk and RAM provided in a server system connected with a dedicated communication network and Internet as the recording medium, to provide the programs to the computer 900 via the network and to provide them to the image capturing apparatus 120 or the control apparatus 130 from the computer 900 via the network 160.

Although the invention has been described by way of the exemplary embodiments, it should be understood that those skilled in the art might make many changes and substitutions without departing from the spirit and scope of the invention.

It is obvious from the definition of the appended claims that the embodiments with such modifications also belong to the scope of the invention.

What is claimed is:

1. A monitoring system, comprising:
a plurality of sensors, provided at different locations, for detecting external environment in each location;
image capturing apparatuses connected with a communication network; and
a control apparatus, connected with said plurality of sensors and said communication network, for controlling said image capturing apparatuses;
wherein said control apparatus comprises:
an environment inputting section for inputting an environment value representing the external environment of the location where said sensor is set from each one of said plurality of sensors; and
a trap control section for transmitting an image capturing direction specifying trap message that is a SNMP-based trap message (Simple Network Management Protocol) instructing to capture images in an image capturing direction set in advance corresponding to said sensor to said image capturing apparatus via said communication network when said environment value inputted from said sensor meets with a preset condition set in advance corresponding to said sensor; and
said image capturing apparatus comprises
a camera section for capturing images;
a driving section for changing the image capturing direction of said camera section; and
a driving control section for controlling said driving section to direct said camera section in said image capturing direction specified by said image capturing direction specifying trap message so that said camera section captures images in said image capturing direction.

2. The monitoring system as set forth in claim 1, comprising:
a plurality of sets of said plurality of sensors, said image capturing apparatus and said control apparatus; and
a monitoring apparatus for displaying images captured by one of said image capturing apparatuses;
said trap control section of each of said plurality of control apparatuses transmits an image capturing apparatus specifying trap message that is a SNMP-based trap message containing image capturing apparatus identifying information for identifying said image capturing apparatus controlled by said control apparatus to said monitoring apparatus when said environment value inputted from said sensor meets with said preset condition; and
said monitoring apparatus selects and displays images captured by said image capturing apparatus specified by said image capturing apparatus identifying information contained in said image capturing apparatus specifying trap message among a plurality of images captured respectively by said plurality of image capturing apparatuses.

3. The monitoring system as set forth in claim 1, wherein
said control apparatus has a magnification selecting section for selecting magnification of images captured by said image capturing apparatus based on said environment value;
said trap control section transmits a magnification specifying trap message that is a SNMP-based trap message containing said magnification to said image capturing apparatus via said communication network; and
said image capturing apparatus further includes a magnification control section for setting the magnification of the images captured by said image capturing apparatus to said magnification contained in said magnification specifying trap message received via said communication network.

4. The monitoring system as set forth in claim 3, wherein at least one of said sensors is a temperature sensor for detecting temperature at the location where said sensor is set; and when temperature detected by said temperature sensor is high, said magnification selecting section selects lower magnification as compared to a case when the temperature is low.

5. The monitoring system as set forth in claim 1, wherein
said trap control section transmits said image capturing direction specifying trap message containing sensor identifying information for identifying the sensor to said image capturing apparatus when said environment value inputted from said sensor meets with a preset condition set in advance corresponding to said sensor;
said image capturing apparatus comprises:
an image capturing direction storage section for storing sensor identifying information for identifying each of said plurality of sensors and image capturing direction information representing an image capturing direction in which said camera section should capture images when said environment value inputted from said sensor meets with said preset condition; and
an image capturing direction information selecting section for selecting said image capturing direction information corresponding to said sensor identifying information contained in said image capturing direction specifying trap message received via said communication network from said image capturing direction storage section; and
said driving control section controls said driving section based on said selected image capturing direction information to direct said camera section in an image capturing direction defined by said image capturing direction information and to cause said camera section to capture images in the image capturing direction.

6. The monitoring system as set forth in claim 5, wherein
said control apparatus further includes a sensor combination identifying information generating section for generating sensor combination identifying information for identifying a combination of said sensors whose environment values meet with said preset condition when said environment values of two or more sensors meet with said preset condition;
said trap control section transmits said image capturing direction specifying trap message containing said sensor combination identifying information to said image capturing apparatus via said communication network;
said image capturing direction storage section further stores said sensor combination identifying information and said image capturing direction information representing an image capturing direction in which said camera section should capture images when said environment values of said two or more sensors contained in the combination of said sensors identified by said sensor combination identifying information meet with said preset condition; and
said image capturing direction information selecting section selects said image capturing direction information corresponding to said sensor combination identifying information contained in said image capturing direction specifying trap message received via said communication network from said image capturing direction storage section.

7. The monitoring system as set forth in claim 5, wherein
each one of said plurality of sensors is a temperature sensor for detecting temperature at the location where said sensor is set;
said control apparatus further includes
a target image capturing direction deciding section for deciding a target image capturing direction in which said image capturing apparatus should capture images based on temperature detected by each one of two or more temperature sensors that has detected temperature exceeding preset temperature when the temperature detected by each one of said two or more temperature sensors exceeds said preset temperature set as said preset condition of said temperature sensors;
a temperature sensor selecting section for selecting one of said temperature sensors that has detected the temperature exceeding the preset temperature set as said preset condition; and
a difference information calculating section for calculating difference information representing a difference between said target image capturing direction and said image capturing direction defined by said image capturing direction information stored in said image capturing direction storage section corresponding to one of said temperature sensors;
said trap control section transmits said image capturing direction specifying trap message containing said sensor identifying information of one of said temperature sensors and image capturing direction difference specifying trap message that is a SNMP-based trap message containing said difference information respectively to said image capturing apparatus via said communication network; and
said driving control section controls said driving section based on said image capturing direction information corresponding to said sensor identifying information of one of said temperature sensors contained in said image capturing direction specifying trap message and said difference information contained in said image capturing direction difference specifying trap message to direct said image capturing apparatus in said target image capturing direction and to cause said image capturing apparatus to capture images in said image capturing direction.

8. The monitoring system as set forth in claim 1, further comprising:
a monitoring apparatus for displaying the image captured by said image capturing apparatus and when the manager of said monitoring apparatus inputs an instruction of changing the image capturing direction in which said image capturing apparatus is capturing the image, for transmitting an image capturing direction changing request message containing said instruction to said control apparatus; wherein
said trap control section transmits an image capturing direction changing trap message that is a SNMP-based trap message instructing to change said image capturing direction in the direction specified by said image capturing direction changing request message when it receives said image capturing direction changing request message from said monitoring apparatus; and
said driving control section of said image capturing apparatus directs said camera section in said image capturing direction specified by said image capturing direction changing trap message by controlling said driving section when it receives said image capturing direction changing trap message.

9. The monitoring system as set forth in claim 8, further comprising:
first and second ones of said monitoring apparatuses; wherein
said trap control section transmits an image capturing apparatus specifying trap message that is a SNMP-based trap message further to said first monitoring apparatus when the environment value inputted from said sensor meets with said preset condition;
said first monitoring apparatus displays the image captured by said image capturing apparatus when it receives said image capturing apparatus specifying trap message;
said trap control section transmits said image capturing direction changing trap message instructing to change said image capturing direction in the direction specified by said image capturing direction changing request message to said image capturing apparatus when it receives said image capturing direction changing request message from said first monitoring apparatus or when it receives said image capturing direction changing request message from said second monitoring apparatus in a state in which no image capturing apparatus specifying trap message is transmitted to said first monitoring apparatus for a period determined in advance; and
said driving control section of said image capturing apparatus controls said driving section to direct said camera section in said image capturing direction specified by said image capturing direction changing trap message when it receives said image capturing direction changing trap message.

10. The monitoring system as set forth in claim 9, wherein
said trap control section also transmits a manipulation prohibiting trap message that is a SNMP-based trap message representing that no instruction of changing the image capturing direction in which said image capturing apparatus captures images will be accepted from said second monitoring apparatus to said second monitoring apparatus when the environment value inputted from said sensor meets with said preset condition; and
said second monitoring apparatus prohibits the manger of the second monitoring apparatus from changing said image capturing direction for a period set in advance when it receives said manipulation prohibiting trap message.

11. The monitoring system as set forth in claim 9, wherein
said trap control section also transmits a manipulation prohibiting trap message that is a SNMP-based trap message representing that no instruction of changing the image capturing direction in which said image capturing apparatus captures images will be accepted from said second monitoring apparatus to said second monitoring apparatus when the environment value inputted from said sensor meets with said preset condition; and
said second monitoring apparatus displays images captured before receiving said manipulation prohibiting trap message for a period set in advance when it receives said manipulation prohibiting trap message.

12. The monitoring system as set forth in claim 1, further comprising:
a plurality of said image capturing apparatuses;
a monitoring apparatus for displaying images captured by one of said image capturing apparatuses; and
an image selecting unit for selecting an image to be displayed on said monitoring apparatus among images captured respectively by said plurality of image capturing apparatuses to transmit said image to said monitoring apparatus;
said control apparatus further includes
a sensor correlated information storage section for storing sensor identifying information for identifying each of said plurality of sensors by correlating with image capturing apparatus identifying information for identifying said image capturing apparatus whose captured image should be transmitted to said monitoring apparatus among said plurality of image capturing apparatuses when said environment value inputted from said sensor meets with said preset condition; and
an image capturing apparatus identifying information selecting section for selecting said image capturing apparatus identifying information correlating with said sensor out of said sensor correlated information storage section when said environment value inputted from said sensor meets with said preset condition;
said trap control section transmits an image capturing apparatus selecting trap message that is a SNMP-based trap message containing said image capturing apparatus identifying information selected by said image capturing apparatus identifying information selecting section to said image selecting unit via said communication network; and
said image selecting unit selects the image captured by said image capturing apparatus specified by said image capturing apparatus identifying information contained in said image capturing apparatus selecting trap message as the image to be displayed on said monitoring apparatus and transmits said image to said monitoring apparatus.

13. The monitoring system as set forth in claim 1, further comprising:
a plurality of sets of said plurality of sensors, said image capturing apparatus and said control apparatus; and
a plurality of monitoring apparatuses for displaying images captured by one of said image capturing apparatuses; wherein
each of said control apparatuses further includes a preset condition storage section for storing said preset condition corresponding to each of said plurality of sensors in response to each of said plurality of monitoring apparatuses;
said trap control section of each of said control apparatuses transmits said image capturing direction specifying trap message instructing to capture images in an image capturing direction set in advance corresponding to said sensor to said image capturing apparatus controlled by said control apparatus via said communication network and transmits an image capturing apparatus specifying trap message that is a SNMP-based trap message containing image capturing apparatus identifying information for identifying said image capturing apparatus controlled by said control apparatus to said monitoring apparatus when said environment value inputted from said sensor connected to said control apparatus meets with said preset condition corresponding to said monitoring apparatus and said sensor for each of said plurality of monitoring apparatuses; and
each of said plurality of monitoring apparatuses selects and displays the image captured by said image capturing apparatus specified by said image capturing apparatus identifying information contained in said image capturing apparatus specifying trap message among the plurality of images captured respectively by said plurality of image capturing apparatuses.

14. A monitoring system, comprising:
a plurality of sets of a plurality of sensors set at different locations to detect external environment at each location, an image capturing apparatus connected to a communication network and a control apparatus, connected with said plurality of sensors and said communication network, for controlling said image capturing apparatus; and
a monitoring apparatus for displaying an image captured by one of said image capturing apparatuses;
each one of said plurality of control apparatuses has
an environment inputting section for inputting an environment value representing the external environment at the location where the sensor is set from each one of said plurality of sensors connected with the control apparatus; and
a message control section for transmitting an image capturing direction specifying message instructing to capture an image in an image capturing direction set in advance corresponding to the sensor to said image capturing apparatus controlled by said control apparatus via said communication network with which said control apparatus is connected and for transmitting an image capturing apparatus specifying message containing image capturing apparatus identifying information for identifying said control apparatus to said monitoring apparatus when said environment value inputted from said sensor meets with a preset condition set in advance corresponding to said sensor;
each one of said plurality of image capturing apparatuses comprises:
a camera section for capturing images;
a driving section for changing an image capturing direction of said camera section; and
a driving control section for controlling said driving section to direct said camera section in said image capturing direction specified by said image capturing direction specifying message and to cause said camera section to capture the image in said image capturing direction; and
said monitoring apparatus selects and displays the image captured by said image capturing apparatus specified by said image capturing apparatus identifying information contained in said image capturing apparatus specifying message among a plurality of images captured respectively by said plurality of image capturing apparatuses.

15. A control apparatus, connected with a plurality of sensors and a communication network, for controlling au image capturing apparatus in a monitoring system having said plurality of sensors set at different locations to detect external environment at each location and said image capturing apparatus connected with said communication network, comprising:
an environment inputting section for inputting an environment value representing the external environment at the location where said sensor is set from said plurality of sensors; and
a trap control section for transmitting an image capturing direction specifying trap message that is a SNMP (Simple Network Management Protocol)-based trap message instructing to capture an image in an image capturing direction set in advance corresponding to the sensor to said image capturing apparatus via said communication network to cause said image capturing apparatus to capture the image in the image capturing direction specified by said image capturing direction specifying trap message when said environment value inputted from said sensor meets with a preset condition set in advance corresponding to said sensor.

16. A control apparatus in a monitoring system having a plurality of sets of a plurality of sensors set at different locations to detect external environment at each location, an image capturing apparatus connected with a communication network and a control apparatus, connected with said plurality of sensors and said communication network, for controlling said image capturing apparatus as well as a monitoring apparatus for displaying an image captured by one of said image capturing apparatuses; comprising:
an environment inputting section for inputting an environment value representing the eternal environment at the location where said sensor is set from said plurality of sensors connected with said control apparatus; and
a message control section for transmitting an image capturing direction specifying message inducting to capture an image in an image capturing direction set in advance corresponding to the sensor to said image capturing apparatus controlled by said control apparatus via said communication network to cause said image capturing apparatus to capture the image in the image capturing direction specified by said image capturing direction specifying trap message and for transmitting an image capturing apparatus specifying message containing image capturing apparatus identifying information for identifying said image capturing apparatus to said monitoring apparatus to cause said monitoring apparatus to select and display the image captured by said image capturing apparatus when said environment value inputted from said sensor meets with a preset condition set in advance corresponding to said sensor.

17. An image capturing apparatus in a monitoring system having a plurality of sensors set at different locations to detect external environment at each location, an image capturing apparatus connected with a communication network and a control apparatus, connected with said plurality of sensors and said communication network, for controlling said image capturing apparatus; wherein
said control apparatus has
an environment inputting section for inputting an environment value representing the external environment at the location where said sensor is set from said plurality of sensors; and
a trap control section for transmitting an image capturing direction specifying trap message that is a SNMP (Simple Network Management Protocol)-based trap message instructing to capture an image in an image capturing direction set in advance corresponding to the sensor to said image capturing apparatus via said communication network when said environment value inputted from said sensor meets with a preset condition set in advance corresponding to said sensor,
said image capturing apparatus has
a camera section for capturing images;
a driving section for changing an image capturing direction of said camera section; and
a driving control section for controlling said driving section to direct said camera section in said image capturing direction specified by said image capturing direction specifying trap message and to cause said camera section to capture the image in said image capturing direction.
